(19) United States
(12) Patent Application Publication
(10) Pub. No.: US 2020/0160640 A1
(43) Pub. Date: May 21, 2020

(54) VOTER DEVICE, SYSTEM, AND METHODS OF MAKING AND USING SAME

(71) Applicant: Daniel Bernard Ruskin, Westport, CT (US)

(72) Inventor: Daniel Bernard Ruskin, Westport, CT (US)

(21) Appl. No.: 16/211,678

(22) Filed: Dec. 6, 2018

Related U.S. Application Data
(60) Provisional application No. 62/767,759, filed on Nov. 15, 2018.

(51) Int. Cl. G07C 13/00; H04L 9/06; H04L 9/32; G06Q 50/26

(52) U.S. Cl. CPC G07C 13/00; H04L 9/0637; H04L 2209/463; G06Q 50/26; G06Q 2230/00; H04L 9/3265

(57) ABSTRACT

A non-volatile computer readable medium is disclosed comprising computer program instructions that, when executed by at least one hardware processor, configure the at least one hardware processor to: collect a candidate choice from a voter; send a proposed ballot to a vote server over a computer network; receive a first recorded ballot from the vote server over the computer network, wherein the first recorded ballot comprises a digital signature and the digital signature is generated by the vote server; and send the first recorded ballot to an audit server over the computer network. Corresponding systems and methods are also disclosed.

### CROSS-REFERENCE TO RELATED APPLICATION

This application claims priority from U.S. Provisional Application No. 62/767,759, filed 15 Nov. 2018.

### BACKGROUND

This disclosure relates generally to election systems, and more particularly to voter-verifiable electronic election systems that minimize the use of excessive computational, memory, or networking resources.

Non-voter-verifiable election systems are generally known. Non-voter-verifiable election systems have features including collecting ballots from voters and aggregating said ballots into final election results (i.e. tallies). It is problematic when participants in the non-voter-verifiable election systems maliciously tamper with the ballots prior to inclusion in the final election results. In this scenario, voters have no recourse because non-voter-verifiable election systems do not allow voters to detect such ballot tampering.

Voter-verifiable blockchain-based election systems have been proposed. Voter-verifiable blockchain-based election systems have features including collecting ballots from voters, aggregating said ballots into final election results, and allowing voters to detect ballot tampering. However, existing voter-verifiable blockchain-based election systems make use of inefficient blockchain systems. Existing blockchain systems are undesirable because they require a large amount of computing, memory, and networking resources. Specifically, existing blockchain systems comprise blocks which are transmitted to various network peers. In the use of existing blockchain systems, substantial computing resources are needed to generate blocks, substantial memory resources are needed to store blocks, and substantial networking resources to needed to transmit blocks over a network.

It would be useful to develop a election device, system, and method that minimizes the use of computing, memory, and networking resources, but still allows voters to detect ballot tampering.

### SUMMARY

One embodiment described herein is a non-volatile computer readable medium comprising computer program instructions that, when executed by at least one hardware processor, configure the at least one hardware processor to: collect a candidate choice from a voter; send a proposed ballot to a vote server over a computer network; receive a first recorded ballot from the vote server over the computer network, wherein the first recorded ballot comprises a digital signature and the digital signature is generated by the vote server; and send the first recorded ballot to an audit server over the computer network.

Another embodiment described herein is a system comprising a first hardware processor configured to: collect a candidate choice from a voter; send a proposed ballot to a vote server over a computer network; receive a recorded ballot from the vote server over the computer network, wherein the recorded ballot comprises a digital signature and the digital signature is generated by the vote server, and send the recorded ballot to an audit server over the computer network.

Yet another embodiment described herein is a method of conducting an electronic election that is implemented by at least one hardware processor, the method comprising: collecting a candidate choice from a voter; sending a proposed ballot to a vote server over a computer network; receiving a first recorded ballot from the vote server over the computer network, wherein the first recorded ballot comprises a digital signature and the digital signature is generated by the vote server and sending the first recorded ballot to an audit server over the computer network.

Yet another embodiment described herein is a non-volatile computer readable medium comprising computer program instructions that, when executed by at least one computer system, configure the at least one computer system to: collect one or more candidate choices from a voter; send one or more proposed ballots to a vote server over a computer network, wherein each of said one or more proposed ballots comprises one or more of said candidate choices; receive one or more recorded ballots from a vote server over a computer network, wherein each of said one or more recorded ballots comprises one or more vote server digital signatures; send one or more of said recorded ballots to one or more audit servers over a computer network; receive one or more trees over a computer network; and validate that one or more of said recorded ballots are included in one or more of said trees.

Yet another embodiment described herein is a method of manufacturing a non-volatile computer readable medium, comprising the steps of: assembling said medium; loading one or more configuration settings onto said medium, wherein said configuration settings comprise a voter device public key, a voter device private key, and one or more computer program instructions, and wherein said private key is unique to a voter; and supplying said medium to said voter.

Yet another embodiment described herein is a system comprising at least one computer system configured to collect one or more candidate choices from a voter; send one or more proposed ballots to a vote server over a computer network, wherein each of said one or more proposed ballots comprises one or more of said candidate choices; receive one or more recorded ballots from a vote server over a computer network, wherein each of said one or more recorded ballots comprises one or more vote server digital signatures; send one or more of said recorded ballots to one or more audit servers over a computer network; receive one or more trees over a computer network; and validate that one or more of said recorded ballots are included in one or more of said trees.

Yet another embodiment described herein is a method of conducting an electronic election that is implemented by at least one computer system, the method comprising collecting one or more candidate choices from a voter; sending one or more proposed ballots to a vote server over a computer network, wherein each of said one or more proposed ballots comprises one or more of said candidate choices; receiving one or more recorded ballots from a vote server over a computer network, wherein each of said one or more recorded ballots comprises one or more vote server digital signatures; sending one or more of said recorded ballots to one or more audit servers over a computer network; receiving one or more trees over a computer network; and validating that one or more of said recorded ballots are included in one or more of said trees.

### BRIEF DESCRIPTION OF THE DRAWINGS

FIG. 1A depicts a first embodiment of the election method.

FIG. 1B depicts a first embodiment of the pre-election stage of the election method.

FIG. 1C depicts a first embodiment of the ballot casting stage of the election method.

FIG. 1D depicts a first embodiment of the tallying stage of the election method.

FIG. 1E depicts a first embodiment of the voter device audit stage of the election method.

FIG. 1F depicts a first embodiment of the election complete stage of the election method.

FIG. 2A depicts the overall security model of the first embodiment of the election method.

FIG. 2B depicts a plurality of security threats that threaten the first election integrity guarantee.

FIG. 2C depicts a plurality of security threats that threaten the second election integrity guarantee.

FIG. 2D depicts a plurality of security threats that threaten the third election integrity guarantee.

FIG. 2E depicts a plurality of security threats that threaten the fourth election integrity guarantee.

FIG. 2F depicts a plurality of security threats that threaten the fifth election integrity guarantee.

FIG. 2G depicts a plurality of security threats that threaten the sixth election integrity guarantee.

FIG. 3 depicts a first embodiment of the voter device.

FIG. 4 depicts a first embodiment of the voter device manufacturing method.

FIG. 5A depicts the various states of the first embodiment of the voter device.

FIG. 5B depicts the first embodiment of the voter device in the powered-off state.

FIG. 5C depicts the first embodiment of the voter device in the pre-election state.

FIG. 5D depicts the first embodiment of the voter device in the first substrate of the ballot casting state.

FIG. 5E depicts the first embodiment of the voter device in the second substrate of the ballot casting state.

FIG. 5F depicts the first embodiment of the voter device in the third substrate of the ballot casting state.

FIG. 5G depicts the first embodiment of the voter device in the election complete state.

FIG. 5H depicts the first embodiment of the voter device in the error state.

FIG. 6 depicts a first embodiment of the proposed ballot.

FIG. 7 depicts a first embodiment of the recorded ballot.

FIG. 8 depicts a first embodiment of the signed binary merkle tree.

FIG. 9 depicts a first embodiment of the binary merkle tree generation method.

FIG. 10 depicts a first embodiment of the signed partial binary merkle tree.

FIG. 11 depicts a first embodiment of the partial binary merkle tree generation method.

FIG. 12 depicts a first embodiment of the merkle tree node.

FIG. 13 depicts a first embodiment of the vote server manufacturing method.

FIG. 15 depicts a first embodiment of the audit server manufacturing method.

FIG. 16 depicts a network diagram of the first embodiment of the election system.

FIG. 17 depicts a first embodiment of the election metadata.

FIG. 18 depicts a first embodiment of the audit server ballot submission success.

FIG. 19 depicts a first embodiment of the tally as well as an example of said first.

FIG. 20 depicts a first embodiment of the public repository success response.

FIG. 21 depicts a network diagram of the second embodiment of the election system.

FIG. 22 depicts a first embodiment of the public repository manufacturing method.

FIG. 23 depicts a first embodiment of a computer system that may implement the vote server, audit servers, and/or voter devices.

### DETAILED DESCRIPTION

The disclosed embodiments provide a voter device 1, an election system 1601, and an election method 169. The disclosed election system 1601 comprises four components: one or more voter devices 1, a vote server 37, a public repository 47, and one or more audit servers 45. Each of these components may be implemented by one or more computer systems 2301. The disclosed election method assumes that voter devices 1 have been distributed to eligible voters prior to an election, such as by election administrators. After the polls open for an election and a voter device 1 is powered on, the voter device 1 collects one or more candidate choices 603 from a voter, generates a proposed ballot 609, and sends the proposed ballot 609 to the vote server 37. The vote server 37 then records the proposed ballot 609 and returns a recorded ballot 36 to the voter device 1. The voter device 1 then sends the recorded ballot 36 to the one or more audit servers 45. After the polls close, the vote server 37 generates a tally 51 and a signed binary merkle tree 49 that represent the recorded ballots 36 cast while polls were open. The tally 51 and signed binary merkle tree 49 are published to the public repository 47 and are validated by the one or more audit servers 45. A signed partial binary merkle tree 1007 is also validated by voter devices 1; the signed partial binary merkle tree 1007 is provided to voter devices 1 by the vote server 37 and the one or more audit servers 45. As long as voter devices 1 are honest, the vote server 37 or at least one audit server 45 is honest, and the public repository 47 is honest, a plurality of election integrity guarantees 223 are substantially guaranteed. The voter device 1, vote server 37, public repository 47, audit servers 45, election system 1601, and election method 169 use less computing, memory, and networking resources than existing voting apparatus, systems, and methods. However, the presently disclosed apparatus, systems, and methods still allow voters to detect ballot tampering.

As used herein, the term “hash” refers to a digest of an arbitrary message generated by a one-way hash function.

As used herein, the term “tree” refers to a graph data structure containing one or more nodes that are connected via parent-child relationships, where each node contains some arbitrary data and the overall structure does not contain any cycles.

As used herein, the term “descendants” refers to the children of a given tree node, the children of those children, the children of those children, and so on until the bottom of the tree is reached in all search paths. Tree descendants may be identified by breadth-first search, depth-first search, or any other tree traversal methods that traverse a tree in its entirety.

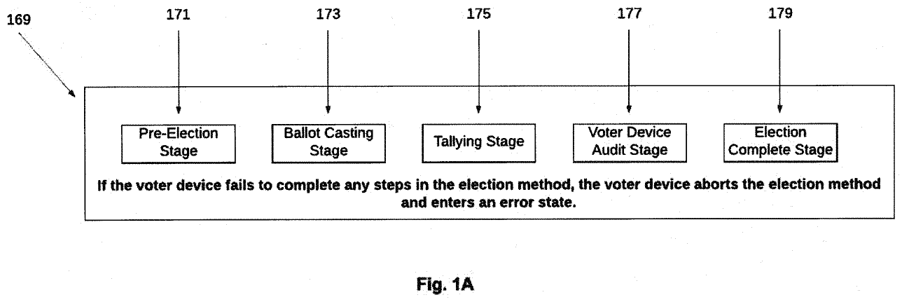

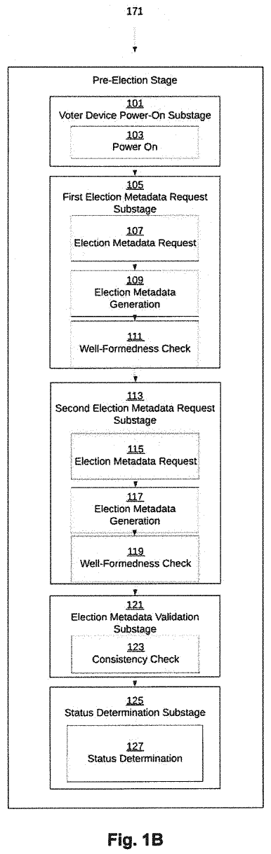

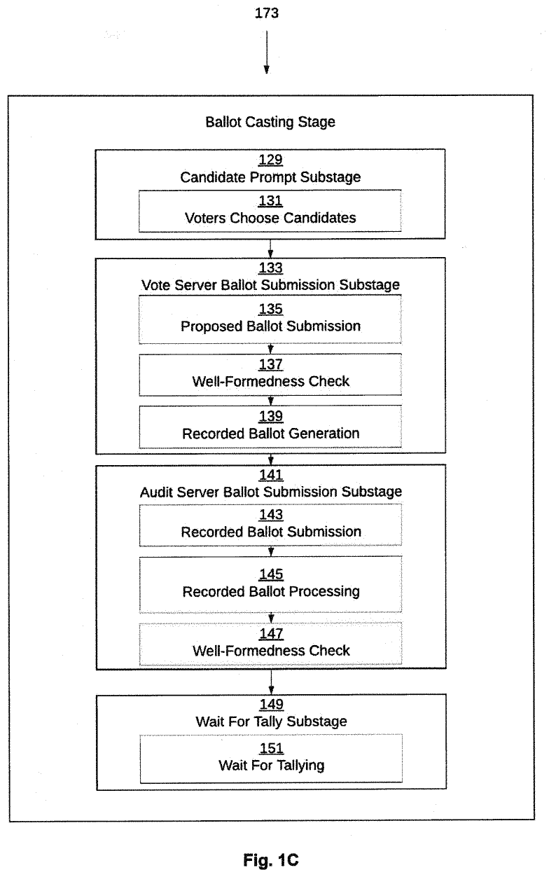

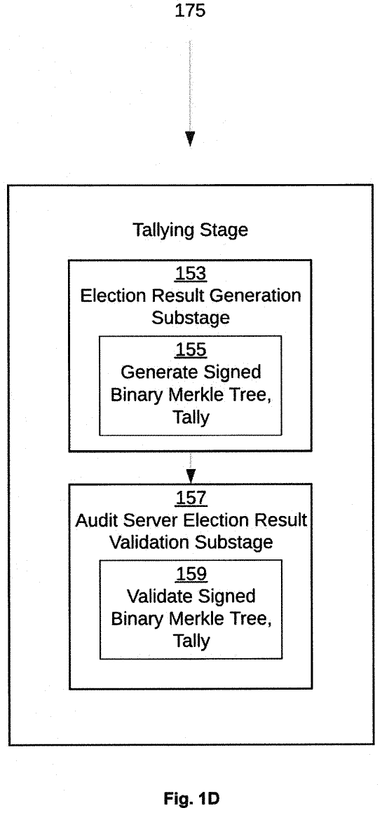

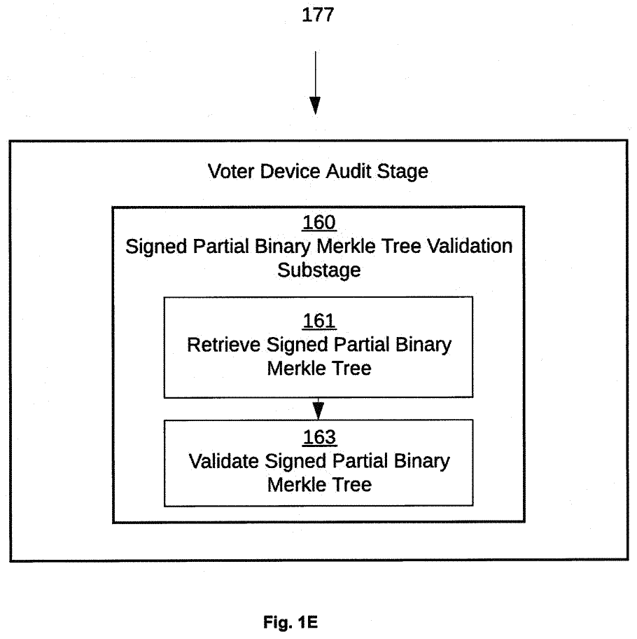

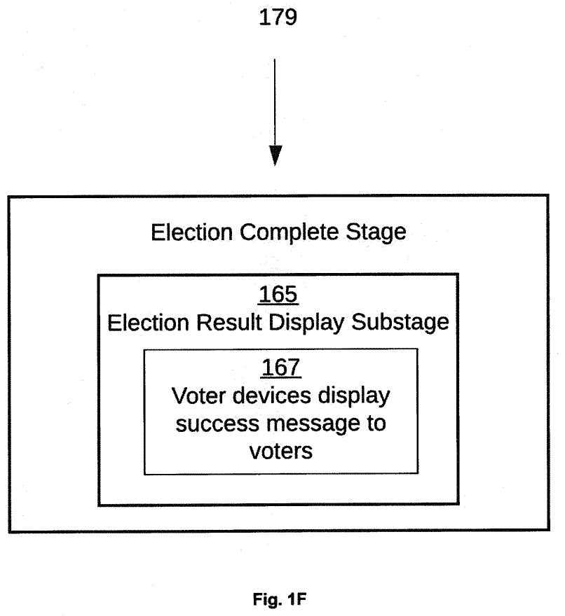

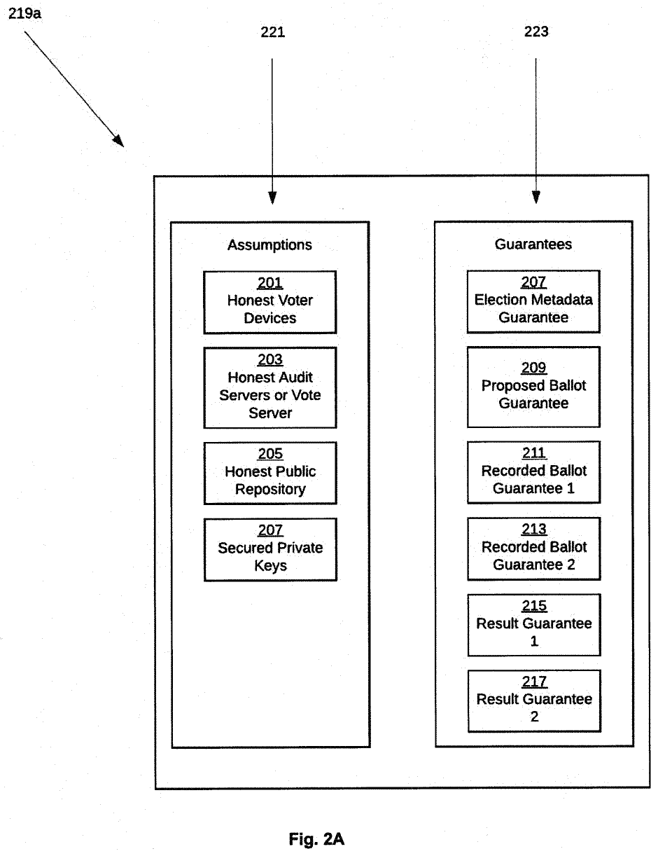

Referring to the drawings, FIG. 1A depicts a first embodiment of the election method 169. The election method 169 comprises five stages: the pre-election stage 171, the ballot casting stage 173, the tallying stage 175, the voter device audit stage 177, and the election complete stage 179.

FIG. 1B depicts a first embodiment of the pre-election stage 171 of the election method 169. The pre-election stage 171 comprises five substages: the voter device power-on substage 101, the first election metadata request substage 105, the second election metadata request substage 113, the election metadata validation substage 121, and the status determination substage 125.

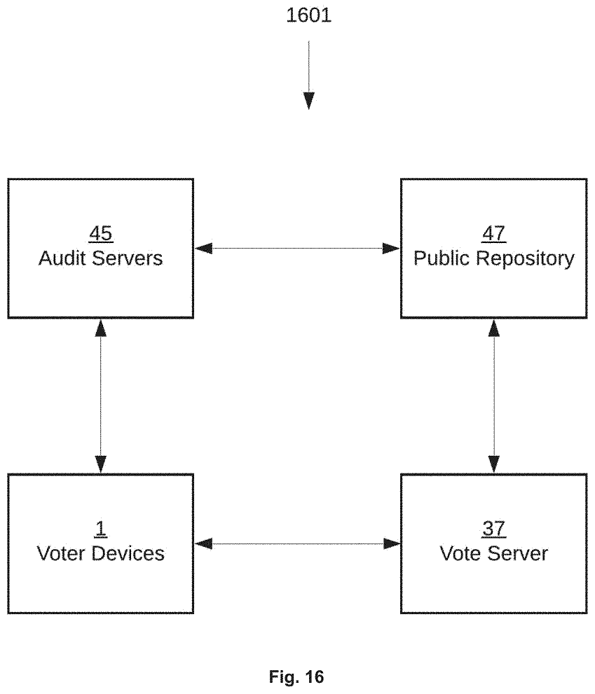

Referring to FIG. 16, the voter device 1 begins the election method 169 by executing the voter device power-on substage 101. The voter device power-on substage 101 comprises step 103. Step 103 comprises each voter powering on their voter device 1. After each voter device 1 is powered on, the voter device 1 immediately proceeds to execute the first election metadata request substage 105.

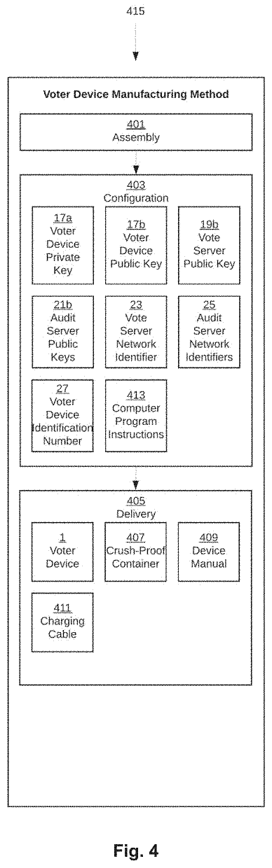

Referring to FIGS. 4, 5, 17, and 23, the first election metadata request substage comprises step 107, step 109, and step 111. The first election metadata request substage begins with voter device executing step 107, which comprises the voter device 1 requesting election metadata 43 from the vote server 37 over a computer network. The vote server 37 responds to said request by executing step 109, which comprises the vote server 37 fetching the election metadata 43 from said vote server's 37 memory 2305, 2307, digitally signing the election metadata 43, and returning the election metadata 43 to the voter device 1 over the computer network. After step 109 completes, the voter device 1 proceeds to execute step 111. Step 111 comprises the voter device 1 validating the well-formedness of the election metadata 43. The well-formedness validation comprises a digital signature validation step in which the vote server digital signature 1709 of the election metadata 43 is validated using the vote servers 37 vote server public key 19b. The vote server's 37 vote server public key 19b is retrieved from the voter device's 1 memory 2305, 2307 for this step. If the well-formedness validation in step 111 succeeds, the voter device 1 saves the election metadata 43 to said voter device's 1 memory 2305, 2307 and proceeds to execute the second election metadata request substage 113. If the well-formedness validation in step 111 fails, the voter device 1 aborts the election method 169 and enters the error state 511. If the voter device 1 cannot perform the well-formedness validation in step 111 because the voter device 1 did not receive election metadata 43 from the vote server 37, the voter device 1 aborts the election method 169 and enters the error state 511.

A wide variety of algorithms can be used to generate and validate digital signatures using public keys and private keys. One such algorithm is the Public-Key Cryptography Standards #1 (PKCS) algorithm published by RSA laboratories. This algorithm allows for the creation of a private key and a mathematically associated public key. A holder of a private key can apply a first mathematical operation to said private key and an arbitrary message to generate a digital signature of the arbitrary message. The holder of the private key can then transmit the message and digital signature to a recipient over a computer network. The recipient can then apply a second mathematical operation to the public key, digital signature, and message to validate that the digital signature represents the true output of the first mathematical operation applied to the private key and message. The recipient does not need to possess the private key to perform the second mathematical operation. If the second mathematical operation indicates that the digital signature is valid, the recipient is substantially guaranteed that the message was digitally signed by a holder of the private key. It is mathematically infeasible for an entity to generate a signature that passes the second mathematical operation applied to a public key, unless said entity possesses the private key associated with said public key.

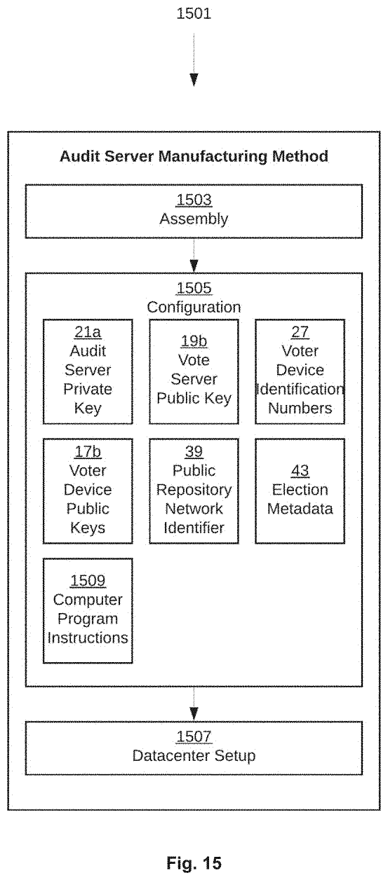

Referring to FIG. 15, second election metadata request substage 113 comprises step 115, step 117, and step 119. The voter device 1 begins executing the second election metadata request substage 113 by executing step 115. Step 115 comprises the voter device 1 requesting election metadata 43 from one or more audit servers 45 over the computer network. The audit servers 45 respond to said requests by executing step 117, which comprises each audit server 45 fetching the election metadata 43 from said audit server's 45 memory 2305, 2307, digitally signing the election metadata 43, and returning the election metadata 43 to the voter device 1 over the computer network. After step 117 completes, the voter device 1 proceeds to execute step 119. Step 119 comprises the voter device 1 validating the well-formedness of the election metadata 43 returned by each audit server 45. The well-formedness validation comprises a digital signature validation step in which the voter device 1 validates the digital signature 1709 of each election metadata 43 using the audit server public key 21b of the audit server 45 that returned the election metadata 43. Each audit server public key 21b is retrieved from the voter device's 1 memory 2305, 2307 for this step. If the well-formedness validation succeeds for all election metadata 43, the voter device 1 saves each election metadata 43 to memory 2305, 2307 and proceeds to execute the election metadata validation substage 121. If the well-formedness validation fails for any election metadata 43, the voter device 1 aborts the election method 169 and enters the error state 511. If the voter device 1 cannot perform a well-formedness validation because the voter device 1 did not receive election metadata 43 from an audit server 45, the voter device 1 aborts the election method 169 and enters the error state 511.

The next substage is the election metadata validation substage 121. The election metadata validation substage 121 comprises step 123. The voter device 1 begins executing the election metadata validation substage 121 by executing step 123, which comprises the voter device 1 validating that all election metadata 43 received from the vote server 37 and audit servers 45 are identical. If all election metadata 43 are identical, the voter device 1 proceeds to execute the status determination substage 125. If the election metadata 43 vary, the voter device 1 aborts the election method 169 and enters the error state 511.

The next substage is the status determination substage 125. The status determination substage 125 comprises step 127. The voter device 1 begins executing the status determination substage 125 by executing step 127, which comprises the voter device 1 determining whether the voter device 1 has previously entered the error state 511. If the voter device 1 has previously entered the error state 511, the voter device 1 immediately aborts the election method 169 and returns to the error state 511. If the voter device 1 has not previously entered the error state 511, the voter device 1 determines whether the voter device 1 has already completed the ballot casting stage 173, whether polls have opened yet, and whether polls have since closed due to the election end time 1703 of the election metadata 43 being reached.

If polls have not yet opened, the voter device 1 waits until polls are open and then proceeds to execute the ballot casting stage 173.

If polls are open and the voter device 1 has not yet completed the ballot casting stage 173, the voter device 1 immediately proceeds to execute the ballot casting stage 173. If polls are open and the voter device 1 has completed the ballot casting stage 173, the voter device 1 waits until the polls are closed and then proceeds to execute the voter device audit stage 177 stage.

If polls have closed and the voter device 1 has not yet completed the ballot casting stage 173, the voter device 1 enters the error state 511 since the voter device 1 can no longer participate in the election. If polls have closed and the voter device 1 has completed the ballot casting stage 173, the voter device 1 determines whether the voter device 1 has completed the voter device audit stage 177; if so, the voter device 1 proceeds to execute the election complete stage 179; otherwise, the voter device 1 proceeds to execute the voter device audit stage 177.

FIG. 1C depicts a first embodiment of the ballot casting stage 173 of the election method 169. The ballot casting stage 173 comprises five substages: the candidate prompt substage 129, the vote server ballot submission substage 133, the voter device recorded ballot validation substage, the audit server ballot submission substage 141, and the wait for tally substage 149.

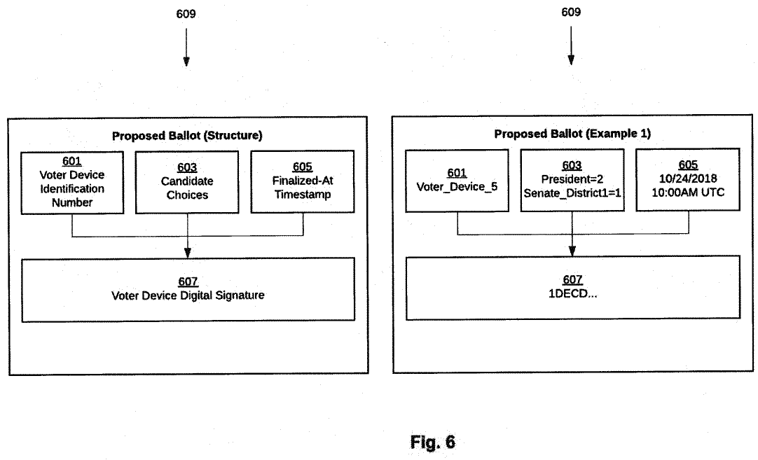

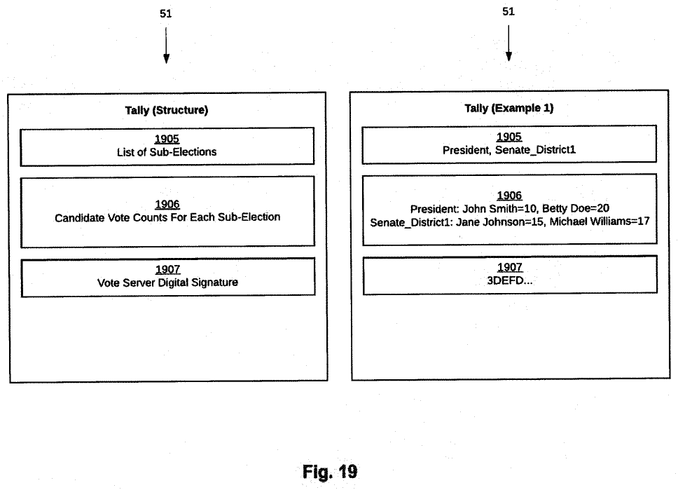

Referring to FIGS. 6 and 19, when a voter device 1 executes the ballot casting stage 173, the voter device 1 begins by executing the candidate prompt substage 129. The candidate prompt substage 129 comprises step 131. The voter device 1 begins executing the candidate prompt substage 129 by executing step 131, which comprises the voter device 1 prompting the voter to submit their candidate choices 603 for each sub-election 1905. After the voter submits their candidate choices 603 for all sub-elections 1905, the voter device 1 proceeds to execute the vote server ballot submission substage 133.

The vote server ballot submission substage 133 comprises step 135, step 137, and step 139. The voter device 1 begins executing the vote server ballot submission substage 133 by executing step 135, which comprises the voter device 1 constructing a proposed ballot 609 from the voter's submitted candidate choices 603 and transmitting the proposed ballot 609 to the vote server 37 over the computer network. The vote server 37 responds to said transmission by executing step 137, which comprises the vote server 37 validating the well-formedness of the proposed ballot 609 submitted by the voter device 1. The well-formedness validation comprises the vote server 37 validating the proposed ballot's 609 voter device digital signature 607. This digital signature validation is performed using the voter device public key 17b corresponding to the voter device 1 that submitted the proposed ballot 609; said voter device public key 17b is retrieved from said the vote server's 37 memory 2305, 2307. If the well-formedness validation in step 137 succeeds, the vote server 37 proceeds to execute step 139. Step 139 comprises the vote server 37 generating a recorded ballot 36 and returning the recorded ballot 36 to the voter device 1 over the computer network. If the well-formedness validation in step 137 fails, the vote server 37 instead returns an error to the voter device 1 over the computer network.

If the voter device 1 does not receive a well-formed recorded ballot 36 from the vote server 37 during step 139, the voter device 1 enters the error state 511. Otherwise, the voter device 1 saves the recorded ballot 36 to said voter device's 1 memory 2305, 2307 and proceeds to execute the audit server ballot submission substage 141.

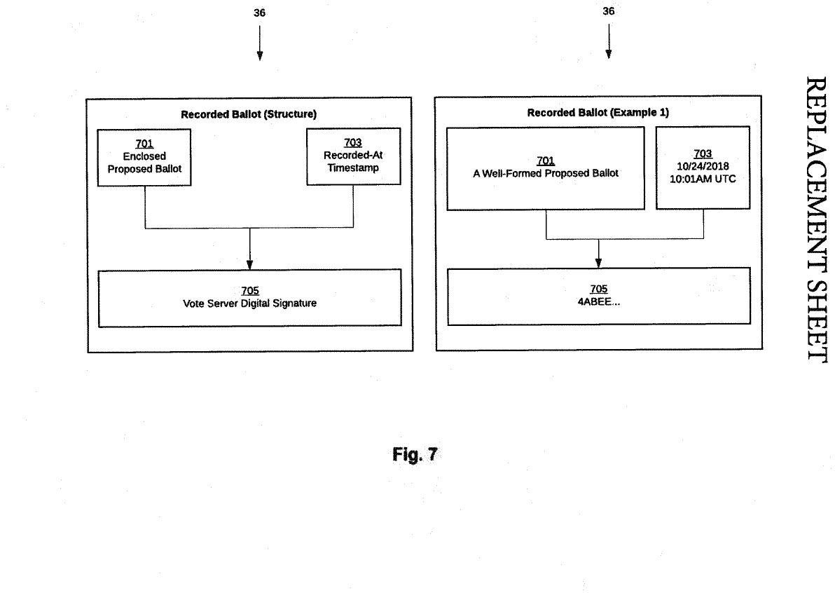

Referring to FIG. 7, when the voter device 1 validates the well-formedness of the recorded ballot 36 during step 139, the well-formedness validation comprises a digital signature validation step in which the recorded ballot's 36 vote server digital signature 705 is validated using the vote server's 37 vote server public key 19b, and the voter device digital signature 607 of the recorded ballot's 36 enclosed proposed ballot 701 is validated using the voter device's 1 voter device public key 17b. The vote server public key 19b and voter device public key 17b are retrieved from the voter device's 1 memory 2305, 2307 for these validations.

In some embodiments, the vote server ballot submission substage 133 may also comprise a procedure in which the vote server 37 prints a paper version of each recorded ballot 36 for future auditing purposes.

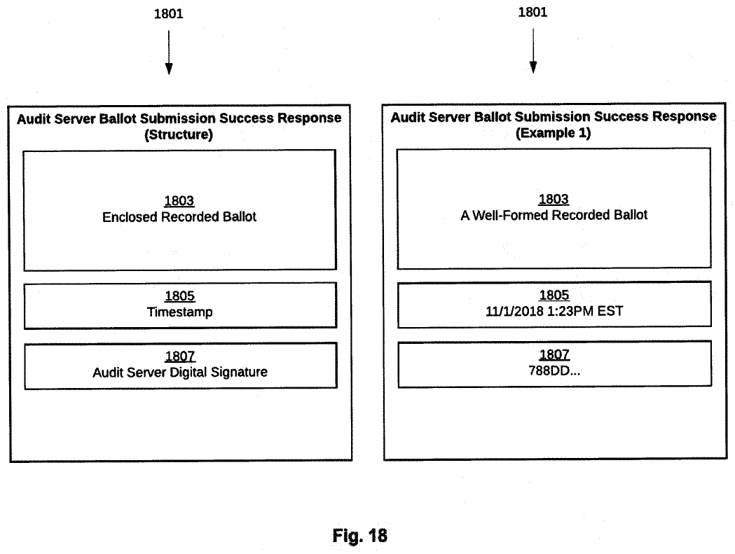

Referring to FIG. 18, the next substage is the audit server ballot submission substage 141. The audit server ballot submission substage 141 comprises step 143, step 145, and step 147. The voter device 1 begins the audit server ballot submission substage 141 by executing step 143. Step 143 comprises the voter device 1 retrieving the recorded ballot 36 that was received during the vote server ballot submission substage 133, and transmitting said recorded ballot 36 to one or more audit servers 45 over the computer network. Each audit server 45 responds to said transmission by executing step 145, which comprises the audit server 45 accepting said recorded ballot 36 and verifying the well-formedness of the recorded ballot 36. If the recorded ballot 36 is well-formed, the audit server 45 saves the recorded ballot 36 to said audit server's 45 memory 2305, 2307 and returns an audit server ballot submission success response 1801 to the voter device 1 over the computer network. If the recorded ballot 36 is malformed, the audit server 45 instead returns an error to the voter device 1. When the audit server 45 validates the well-formedness of the recorded ballot 36 during step 145, the well-formedness validation comprises two digital signature validation steps. The first digital signature validation step comprises the recorded ballot's 36 vote server digital signature 705 being validated using the public key of the vote server 37. The second digital signature validation step comprises the voter device digital signature 607 of the recorded ballot's 36 enclosed proposed ballot 701 being validated using the voter device public key 17b of the voter device 1 that transmitted the recorded ballot 36. The vote server public key 19b and voter device public key 17b are retrieved from the audit server's 45 memory 2305, 2307 for these validations. After the completion of step 145, the voter device 1 immediately proceeds to execute step 147. Step 147 comprises the voter device 1 validating that the audit server ballot submission success responses 1801 received from the audit servers 45 during step 145 are well-formed. If the voter device 1 does not receive a well-formed audit server ballot submission success response 1801 from every audit server 45, the voter device 1 enters the error state 511. Otherwise, the voter device 1 proceeds to execute the wait for tally substage 149.

In some embodiments, the audit server ballot submission substage 141 may also comprise a procedure in which each audit server 45 prints a paper version of the recorded ballot 36 for future auditing purposes.

The final substage of the ballot casting stage 173 is the wait for tally substage 149. The wait for tally substage 149 comprises step 151. The voter device 1 begins executing the wait for tally substage 149 by executing step 151, which comprises the voter device 1 waiting until polls close and the tallying stage 175 completes, then executing the voter device audit stage 177.

Polls close once the election end time 1703 of the election metadata 43 is reached. Once polls close, the tallying stage 175 of the election method 169 begins.

FIG. 1D depicts a first embodiment of the tallying stage 175 of the election method 169. The tallying stage 175 comprises two substages: the election result generation substage 153 and the audit server election result validation substage 157. The tallying stage 175 begins with the vote server 37 executing the election result generation substage 153.

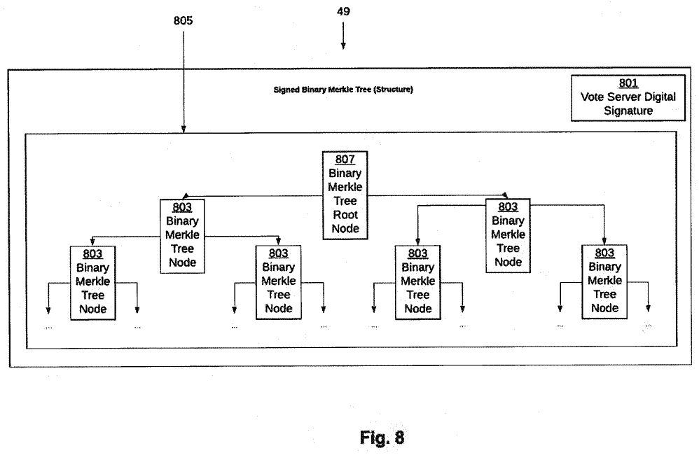

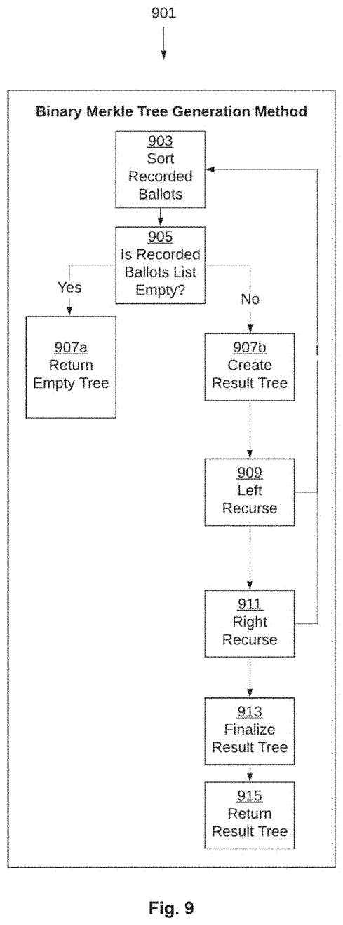

Referring to FIGS. 8, 19, and 20, the election result generation substage 153 comprises step 155. The vote server 37 begins executing the election result generation substage 153 by executing step 155, which comprises the vote server 37 generating a signed binary merkle tree 49 and a tally 51. The signed binary merkle tree 49 comprises a binary merkle tree 805, which in turns comprises all recorded ballots 36 that were received by the vote server 37 during the ballot casting stage 173. Said binary merkle tree 805 is generated using the method depicted in FIG. 9. The vote server 37 then publishes the signed binary merkle tree 49 and tally 51 to a public repository 47 over a computer network. The public repository 47 validates the well-formedness of the signed binary merkle tree 49 and tally 51 on receipt. If the signed binary merkle tree 49 and tally 51 are well-formed, the public repository 47 makes the signed binary merkle tree 49 and tally 51 available for public viewing over the computer network, generates a public repository success response 2001, and returns the public repository success response 2001 to the vote server 37 over the computer network. If the signed binary merkle tree 49 and/or tally 51 are not well-formed, the public repository 47 returns an error to the vote server 37. The vote server 37 raises an alarm during step 155 unless the vote server 37 receives a well-formed public repository success response 2001.

The public repository 47 only accepts a single signed binary merkle tree 49 and tally 51 from the vote server 37. Once the vote server 37 submits a signed binary merkle tree 49 and tally 51 to the public repository 47, the public repository does not allow said signed binary merkle tree 49 or tally 51 to be edited.

When the public repository 47 validates the well-formedness of the signed binary merkle tree 49 and tally 51 during step 155, the well-formedness validation comprises a digital signature validation step in which the vote server digital signature 801 of the signed binary merkle tree 49 and the vote server digital signature 1907 of the tally 51 are validated using the vote server public key 19b. The vote server public key 19b is retrieved from the public repository's 47 memory 2305, 2307 for these validations.

Referring to FIG. 14, immediately after the vote server 37 completes step 155, the audit server 45 proceeds to execute the audit server election result validation substage 157. The audit server election result validation substage 157 comprises step 159. The audit server 45 begins the audit server election result validation substage 157 by executing step 159. Step 159 comprises each audit server 45 requesting the election results 49, 51 from the public repository 47 over the computer network. The public repository 47 responds to these requests by returning a public repository election result response 1401, which comprises an enclosed signed binary merkle tree 1402 and an enclosed tally 1403, which match the binary merkle tree 49 and tally 51 that were transmitted to the public repository 47 during step 155. If an audit server 45 cannot obtain a well-formed public repository election result response 1401, the audit server 45 raises an alarm. If an audit server 45 obtains a public repository election result response 1401, the audit server 45 proceeds to execute one or more audit steps using the public repository election result response's 1401 enclosed signed binary merkle tree and enclosed tally. If any of the audit steps fail, the audit server 45 raises an alarm. Otherwise, the tallying stage 175 completes. In the first embodiment, there are two audit steps.

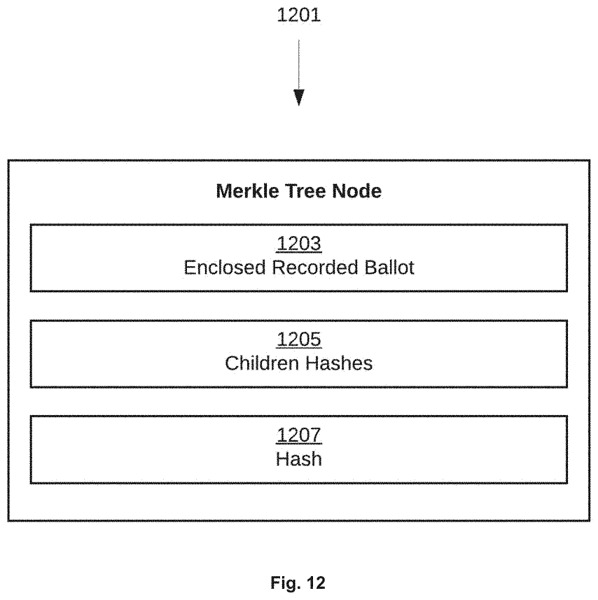

Referring to FIG. 12, the first audit step comprises the audit server 45 validating that the enclosed recorded ballots 1203 of the signed binary merkle tree 49 exactly match the recorded ballots 36 in the audit server's 45 memory 2305, 2307. Recall that the audit server 45 received all recorded ballots 36 cast during the ballot casting stage 173 and stored said recorded ballots 36 in said audit server's 45 memory 2305, 2307. If an enclosed recorded ballot 1203 is not present in the audit server's 45 memory 2305, 2307, the first audit step fails. Likewise, if a recorded ballot 36 in the audit server's 45 memory 2305, 2307 is not present in exactly one enclosed recorded ballot 1203, the first audit step fails.

The second audit step comprises the audit server 45 validating that the tally 51 accurately reflects all recorded ballots 36 in said audit server's 45 memory 2305, 2307. The audit server 45 prepares its own tally 51 from the recorded ballots 36 in said audit server's 45 memory 2305, 2307. The candidate vote counts 1906 of the audit server's 45 tally 51 are then compared against the candidate vote counts 1906 of the tally 51 retrieved from the public repository 47. This audit step fails unless the candidate vote counts 1906 of the audit server's 45 tally 51 exactly match the candidate vote counts 1906 of the published tally 51.

When the audit server 45 validates the well-formedness of the public repository election result response 1401 during step 159, the well-formedness validation comprises a digital signature validation step in which the public repository digital signature 1405 of the public repository election result response 1401 is validated using the public repository public key 41b. The public repository public key 41b is retrieved from the audit server's 45 memory 2305, 2307 for these validations.

An audit server 45 or vote server 37 may raise an alarm at several points during the election method 169. In the first embodiment of the election method 169, said alarms are raised via a physical Light Emitting Diode (LED) on the audit server 45 or vote server 37. In alternative embodiments, an alarm can be raised via any alternative methods that allow for the secure transmission of the alarm, such as encrypted and digitally signed email. After receiving an alarm, election administrators respond to the alarm as appropriate to determine whether election fraud has occurred and to correct such fraud. In some embodiments, the election administrators' response can include a manual review of paper ballots.

After the tallying stage 175 completes, the voter device 1 proceeds to execute the voter device audit stage 177.

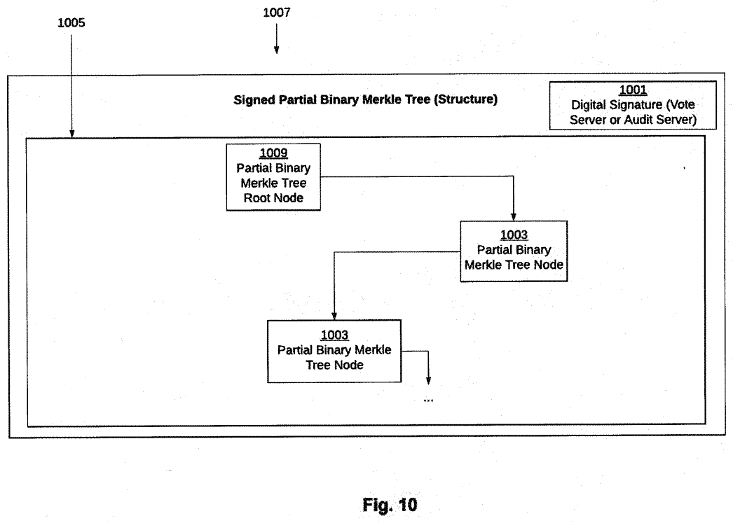

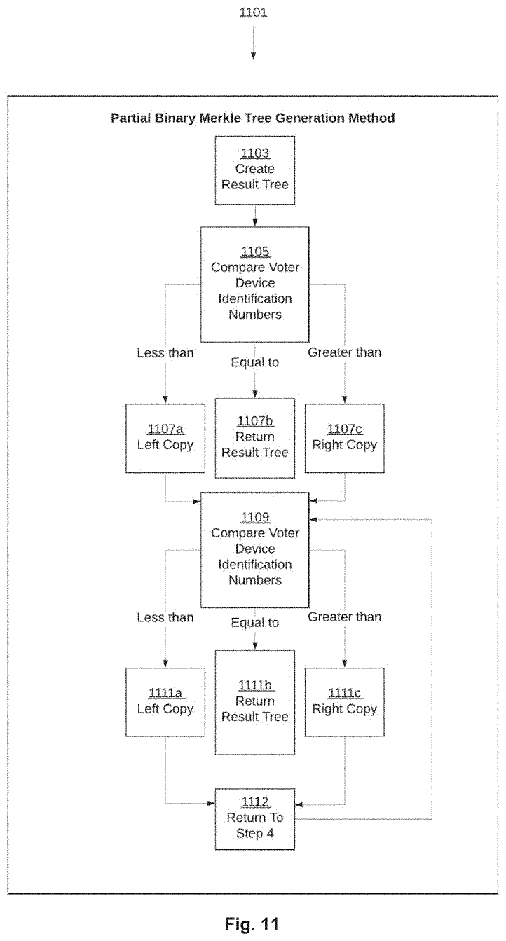

Referring to FIG. 10, FIG. 1E depicts a first embodiment of the voter device audit stage 177 of the election method 169. The voter device audit stage 177 comprises the signed partial binary merkle tree validation substage 160. The signed partial binary merkle tree validation substage 160 comprises step 161 and step 163. The voter device 1 begins executing the voter device audit stage 177 by executing step 161. Step 161 comprises the voter device 1 requesting a signed partial binary merkle tree 1007 from the vote server 37 and one or more audit servers 45 over the computer network. The vote server 37 generates a partial binary merkle tree 1005 for the voter device 1 using the method depicted in FIG. 11, generates a signed partial binary merkle tree 1007 from said partial binary merkle tree 1005, and returns the signed partial binary merkle tree 1007 to the voter device 1 over the computer network. If the vote server 37 cannot complete the method depicted in FIG. 11, the vote server 37 returns an error to the voter device 1. Likewise, each audit server 45 generates a partial binary merkle tree 1005 for the voter device 1 using the method depicted in FIG. 11, generates a signed partial binary merkle tree 1007 from said partial binary merkle tree 1005, and returns the signed partial binary merkle tree 1007 to the voter device 1 over the computer network. If an audit server 45 cannot complete the method depicted in FIG. 11, the audit server 45 returns an error to the voter device 1.

If the voter device 1 does not receive a well-formed signed partial binary merkle tree 1007 from the vote server 37 and every audit server 45, the voter device 1 enters the error state 511 during step 161. Otherwise, the voter device 1 proceeds to execute step 163. Step 163 comprises the voter device 1 performing one or more partial binary merkle tree audit steps. If any of the partial binary merkle tree audit steps fail, the voter device 1 enters the error state 511. If all of the partial binary merkle tree audit steps succeed, the voter device 1 proceeds to execute the election complete stage 179.

In the first embodiment, there are two partial binary merkle tree audit steps.

The first partial binary merkle tree audit step comprises the voter device 1 validating the consistency of the signed partial binary merkle trees 1007 returned by the vote server 37 and audit servers 45. The voter device 1 validates that each of the signed partial binary merkle trees 1007 contain identical partial binary merkle trees 1005. The first partial binary merkle tree audit step fails unless the audit servers 45 and the vote server 37 all return signed partial binary merkle trees 1007 that contain precisely identical partial binary merkle trees 1005. In other words, the first partial binary merkle tree audit step fails if one of the partial binary merkle trees 1005 contains a partial binary merkle tree node 1003 not present in another of the partial binary merkle trees 1005.

The second partial binary merkle tree audit step comprises the voter device 1 validating that the signed partial binary merkle tree 1007 comprises an enclosed recorded ballot 1203 corresponding to the recorded ballot 36 received by the voter device 1 during the ballot casting stage 173. The second partial binary merkle tree audit step fails unless said enclosed recorded ballot 1203 exists and exactly matches the recorded ballot 36 received during the ballot casting stage 173. To complete this validation, the recorded ballot 36 from the ballot casting stage 173 is retrieved from the voter device's 1 memory 2305, 2307.

When the voter device 1 validates the well-formedness of the signed partial binary merkle tree 1007 returned by the vote server 37 during step 161, the well-formedness validation comprises a digital signature validation step in which the digital signature 1001 of said signed partial binary merkle tree 1007 is validated using the vote server public key 19b of the vote server 37. When the voter device 1 validates the well-formedness of the signed partial binary merkle trees 1007 returned by the audit servers 45 during step 161, the well-formedness validation comprises a digital signature validation step in which the digital signatures 1001 of said signed partial binary merkle trees 1007 are validated using the audit server public keys 21b of the audit servers 45. The vote server public key 19b and audit server public keys 21b are retrieved from the voter device's 1 memory 2305, 2307 for these validations.

FIG. 1F depicts a first embodiment of the election complete stage 179 of the election method 169. The election complete stage 179 comprises a single substage: the election result display substage 165. The election result display substage 165 comprises step 167. The voter device 1 begins the election complete stage 179 by executing step 167. Step 167 comprises the voter device 1 displaying a success message to the voter on the digital display 3 that advises the voter that their vote has been successfully counted in the election.

No blockchains are used to execute the first embodiment of the election method 169; all data is transferred between election participants 1, 45, 47, and 37 without the use of a blockchain. The lack of a blockchain in the election method 169 allows the election method 169 to operate with less computing, memory, and networking resources than blockchain-based methods, because the overhead incurred by blocks is removed. Alternative embodiments may comprise the use of a blockchain if a blockchain can be used in a manner that does not require excessive computing, memory, and networking resources.

The voter device 1 enters the error state at several points in the first embodiment of the election method 169. Alternative embodiments of the election method 169 may comprise advanced error handling steps that preempt the need for the voter device 1 to enter the error state. For example, the voter device 1 may retry failed network requests. In addition, the voter device 1 may be configured to proceed with the election method until a certain failure threshold has been reached, such as 50% of network requests failing. Similar advanced error handling steps may also preempt the need for the vote server 37 or audit servers 45 to raise an alarm.

Data transmitted over a computer network may be transmitted in an encrypted format. A wide variety of algorithms can be used to encrypt data. One such algorithm is the Public-Key Cryptography Standards #1 (PKCS) algorithm published by RSA laboratories.

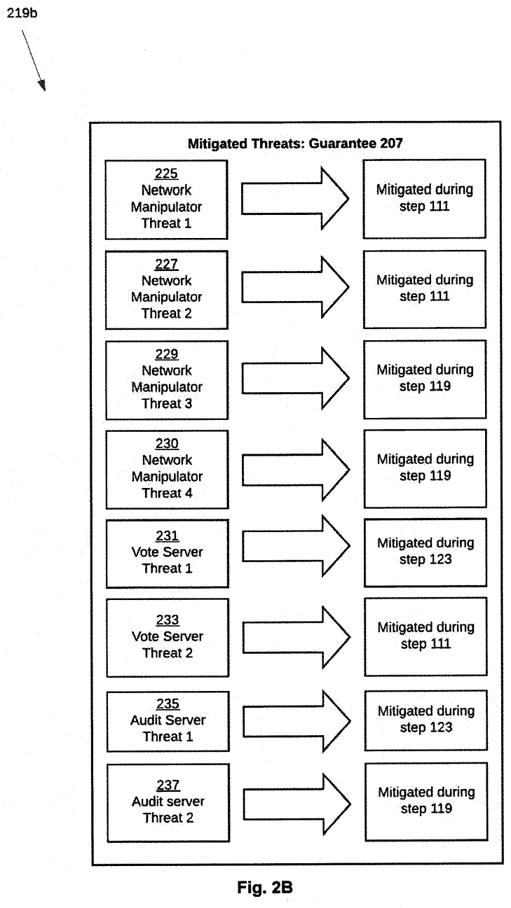

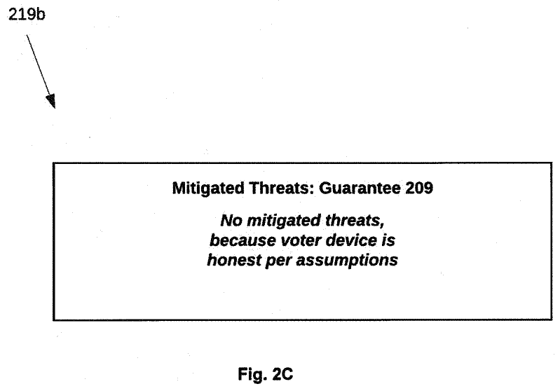

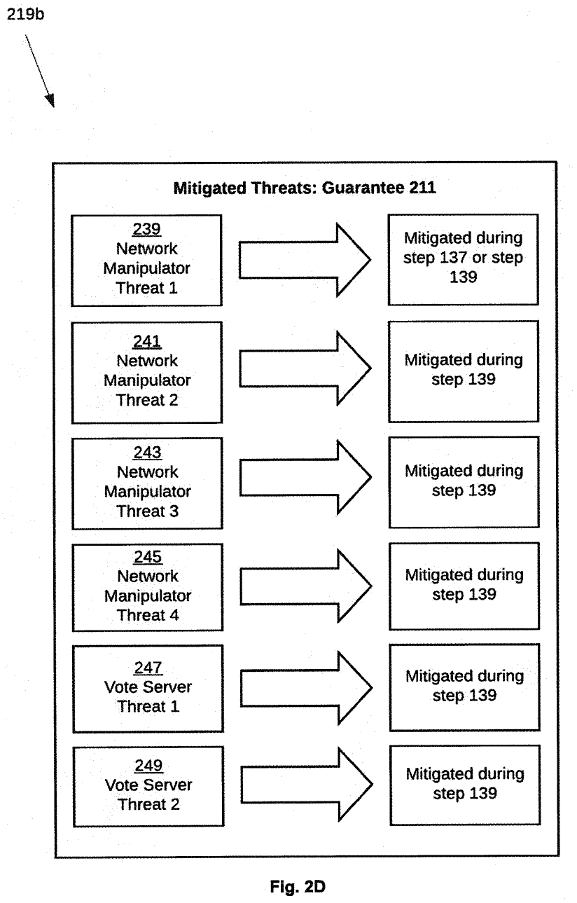

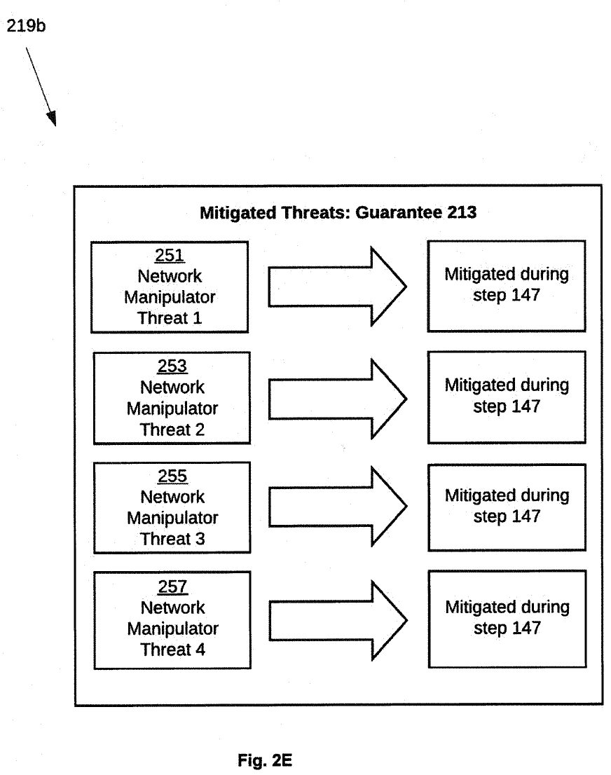

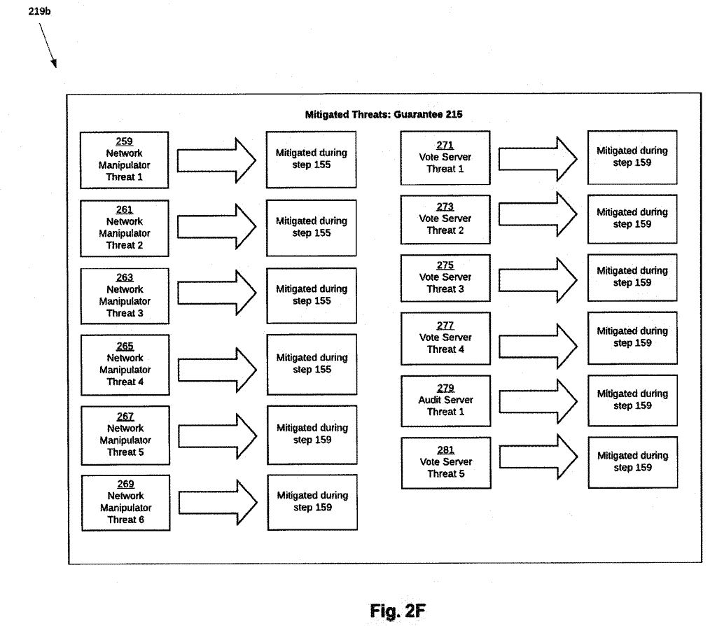

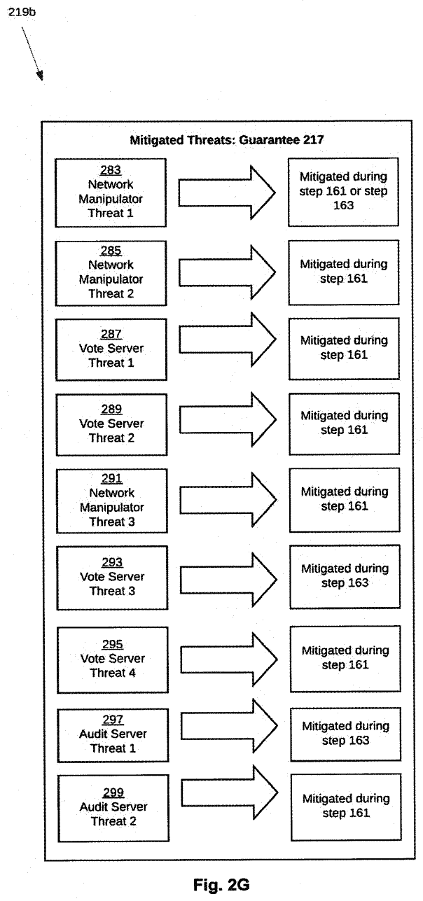

Referring to FIGS. 13 and 22, FIG. 2A depicts the overall security model 219a of the first embodiment of the election method 169. The security model 219a has three assumptions 221. The first assumption 201 is that voter devices 1 follow the election method 169 without any deviations; in other words, the security model 219a assumes that the voter devices 1 are honest. The second assumption 203 is that that the vote server 37 or at least one audit server 45 follows the election method 169 without any deviations; in other words, the security model 219a assumes that the vote server 37 or at least one audit server 45 is honest. The third assumption 205 is that the public repository 47 follows the election method 169 without any deviations; in other words, the security model 219a assumes that the public repository 47 is honest. The fourth assumption 206 is that no private keys have been compromised; in other words, the security model 219a assumes that each audit server private key 21a is only held by the appropriate audit server 45, each voter device private key 17a is only held by the appropriate voter device 1, the vote server private key 19a is only held by the vote server 37, and the public repository private key 41a is only held by the public repository 47.

As long as the assumptions 221 are met, a plurality of election integrity guarantees 223 are substantially guaranteed by the first embodiment of the election method 169.

The first election integrity guarantee 207 is that each voter device 1 either receives valid election metadata 43 during the pre-election stage 171, or enters the error state 511. For the purpose of the first election integrity guarantee 207, valid election metadata 43 is defined as the election metadata 43 that is distributed by an honest audit server 45 or vote server 37.

The second election integrity guarantee 209 is that, if a voter device 1 proceeds to the candidate prompt substage 129 without entering the error state 511, the voter device 1 generates a proposed ballot 609 with candidate choices 603 that reflect the candidate choices 603 submitted by the voter.

The third election integrity guarantee 211 is that, if a voter device 1 proceeds to the candidate prompt substage 129 without entering the error state 511, the vote server 37 either generates and successfully returns a well-formed recorded ballot 36 to the voter device 1, or the voter device 1 enters the error state 511. A recorded ballot 36 is considered successfully returned if the voter device 1 receives and stores the recorded ballot 36 in said voter device's 1 memory 2305, 2307 without entering the error state 511.

The fourth election integrity guarantee 213 is that, if a voter device 1 proceeds to the audit server ballot submission substage 141 without entering the error state 511, the voter device 1 either successfully transmits its recorded ballot 36 to honest audit servers 45, or the voter device 1 enters the error state 511. A recorded ballot 36 is considered successfully transmitted if the audit server 45 receives the recorded ballot 36 and returns a well-formed audit server ballot submission success response 1801 to the voter device 1.

The fifth election integrity guarantee 215 has two components. First, all recorded ballots 36 successfully cast during the ballot casting stage 173 are included without modification in the signed binary merkle tree 49 that is published to the public repository 47, as well as the tally 51 that is published to the public repository 47, or an alarm is raised. A recorded ballot 36 is considered successfully cast if the recorded ballot 36 was successfully generated by the vote server 37 during the vote server ballot submission substage 133, and if the recorded ballot 36 was successfully saved by all audit servers 45 during the audit server ballot submission substage 141. Second, only recorded ballots 36 that were successfully cast during the ballot casting stage 173 are included in said signed binary merkle tree 49 and said tally 51, or an alarm is raised; the signed binary merkle tree 49 and tally 51 either does not contain any recorded ballots 36 that were not successfully cast, or an alarm is raised.

The sixth election integrity guarantee 217 is that, if a voter device 1 successfully proceeds to the wait for tally substage 149 without entering the error state 511, either the recorded ballot 36 received by the voter device 1 during the vote server ballot submission substage 133 is included in the signed binary merkle tree 49 that is published to the public repository 47, or the voter device 1 enters the error state 511.

Considered altogether, the election integrity guarantees 223 provide strong protection for the safety and integrity of elections. As long as the assumptions 221 are met, the election method 169 substantially guarantees that every voter's candidate choices 603 are either included in the final election results 49, 51 without modification, or an alarm is raised and/or the voter device 1 enters the error state 511.

The election integrity guarantees 223 always hold if the election method 169 is followed faithfully by all election participants 1, 45, 47, and 37 without outside interference. However, there are several entities that could seek to threaten the election integrity guarantees 223. The first such entity comprises network manipulators who modify or block data as it passes between the vote server 37, audit servers 45, and voter devices 1 over the computer network. The second such entity comprises a dishonest vote server 37. The third such entity comprises a dishonest audit server 45. The election method 169 protects the election integrity guarantees 223 from a plurality of security threats 219b originating from network manipulators, dishonest vote servers 37, and dishonest audit servers 45, as will now be demonstrated.

A plurality of security threats 219b are analyzed throughout the present disclosure. When a security threat 219b is analyzed in the present disclosure, this analysis is performed with the understanding that none of the other security threats 219b occur concurrently, unless specified otherwise. This understanding allows for clear and concise analysis. This understanding does not affect the validity of the analysis, however; the election method 169 also protects against multiple security threats 219b launched concurrently.

FIG. 2B depicts a plurality of security threats 219b that threaten the first election integrity guarantee 207. Threat 225 to the first election integrity guarantee 207 comprises a network manipulator editing the election metadata 43 while it is in transit to the voter device 1 over the computer network during step 109. Threat 225 could conceivably cause a voter device 1 to receive election metadata 43 other than the true election metadata 43, and thus threatens the first election integrity guarantee 207. However, threat 225 is mitigated during step 111 when the voter device 1 validates the well-formedness of the election metadata 43. In the present scenario, the election metadata 43 is malformed because, due to the network manipulator's edits, the digital signature 1709 no longer represents a valid signature of the election metadata 43 by the vote server 37. As a result, the voter device 1 fails to validate the well-formedness of the election metadata 43 and enters the error state 511 during step 111. The first election integrity guarantee 207 is thus upheld despite the network manipulator's actions.

Threat 227 to the first election integrity guarantee 207 comprises a network manipulator blocking the election metadata 43 while it is in transit to the voter device 1 over the computer network during step 109. The threat 227 could conceivably cause a voter device 1 to not receive the true election metadata 43, and thus threatens the first election integrity guarantee 207. However, threat 227 is mitigated during step 111 when the voter device 1 validates the well-formedness of the election metadata 43. In the present scenario, the voter device 1 cannot complete the well-formedness validation because the election metadata 43 was blocked by the network manipulator. As a result, the voter device 1 enters the error state 511 during step 111, and the first election integrity guarantee 207 is upheld despite the network manipulator's actions.

Threat 229 to the first election integrity guarantee 207 comprises a network manipulator editing the election metadata 43 while it is in transit to the voter device 1 over the computer network during step 117. Threat 229 could conceivably cause a voter device 1 to receive election metadata 43 other than the true election metadata 43, and thus threatens the first election integrity guarantee 207. However, threat 229 is mitigated during step 119 when the voter device 1 validates the well-formedness of the election metadata 43. In the present scenario, the election metadata 43 is malformed because, due to the network manipulator's edits, the digital signature 1709 no longer represents a valid signature of the election metadata 43 by the audit server 45. As a result, the voter device 1 fails to validate the well-formedness of the election metadata 43 and enters the error state 511 during step 119. The first election integrity guarantee 207 is thus upheld despite the network manipulator's actions.

Threat 230 to the first election integrity guarantee 207 comprises a network manipulator blocking the election metadata 43 while it is in transit to the voter device 1 over the computer network during step 117. Threat 230 could conceivably cause a voter device 1 to not receive the true election metadata 43, and thus threatens the first election integrity guarantee 207. However, threat 230 is mitigated during step 119 when the voter device 1 validates the well-formedness of the election metadata 43. In the present scenario, the voter device 1 cannot complete the well-formedness validation because the election metadata 43 was blocked by the network manipulator. As a result, the voter device 1 enters the error state 511 during step 119, and the first election integrity guarantee 207 is upheld despite the network manipulator's actions.

Threat 231 to the first election integrity guarantee 207 comprises the vote server 37 returning election metadata 43 other than the true election metadata 43 to the voter device 1 during step 109. Threat 231 could conceivably cause a voter device 1 to not receive the true election metadata 43, and thus threatens the first election integrity guarantee 207. However, threat 231 is mitigated during step 123 when the voter device 1 validates the consistency of the returned election metadata 43. In the present scenario, because the vote server 37 returned untrue election metadata 43, it must be dishonest. Thus, per the second assumption 203, at least one audit server 45 is honest. The at least one honest audit servers 45 return the true election metadata 43 during step 117. Thus, the voter device 1 receives both untrue and true election metadata 43 during the pre-election stage 171. As a result, the consistency check in step 123 fails and the voter device 1 enters the error state 511. The first election integrity guarantee 207 is upheld despite the vote server's 37 actions.

Threat 233 to the first election integrity guarantee 207 comprises the vote server 37 failing to return election metadata 43 to the voter device 1 during step 109, or returning malformed election metadata 43 to the voter device 1 during step 109. Threat 233 could conceivably cause a voter device 1 to not receive the true election metadata 43, and thus threatens the first election integrity guarantee 207. However, threat 233 is mitigated during step 111 when the voter device 1 validates the well-formedness of the election metadata 43. In the present scenario, step 111 fails because the voter device 1 did not receive well-formed election metadata 43. As a result, the voter device 1 enters the error state 511 during step 111, and the first election integrity guarantee 207 is upheld despite the vote server's 37 actions.

Threat 235 to the first election integrity guarantee 207 comprises an audit server 45 returning incorrect election metadata 43 to the voter device 1 during step 117. Threat 235 could conceivably cause a voter device 1 to not receive the true election metadata 43, and thus threatens the first election integrity guarantee 207. However, threat 235 is mitigated during step 4a when the voter device 1 validates the consistency of the returned election metadata 43. In the present scenario, because an audit server 45 returned untrue election metadata 43, it must be dishonest. Thus, per the second model assumption, at least one audit server 45 or the vote server 37 is honest. It follows that either the vote server 37 returns the true election metadata 43 during step 109, or at least one honest audit server 45 returns the true election metadata 43 during step 117. Thus, the voter device 1 receives both untrue election metadata 43 and true election metadata 43 during the pre-election stage 171. As a result, the consistency check in step 123 fails and the voter device 1 enters the error state 511. The first election integrity guarantee 207 is thus upheld despite the audit server's 45 actions.

Threat 237 to the first election integrity guarantee 207 comprises an audit server 45 failing to return election metadata 43 to the voter device 1 during step 117, or returning malformed election metadata 43 to the voter device 1. Threat 237 could conceivably cause a voter device 1 to not receive the true election metadata 43, and thus threatens the first election integrity guarantee 207. However, threat 237 is mitigated during step 119 when the voter device 1 validates the well-formedness of the election metadata 43. In the present scenario, step 119 fails because the voter device 1 did not receive well-formed election metadata 43. As a result, the voter device 1 enters the error state 511 during step 119. The first election integrity guarantee 207 is thus upheld despite the audit server's 45 actions.

FIG. 2C depicts the security threats 219b that threaten the second election integrity guarantee 209. The second election integrity guarantee 209 is always upheld as long as the assumptions 221 are met. Assumption 201 states that voter devices 1 are honest. The second election integrity guarantee 209 concerns only actions performed on voter devices 1, and is thus implied by assumption 201.

FIG. 2D depicts the security threats that threaten the third election integrity guarantee 211. Threat 239 to the third election integrity guarantee 211 comprises a network manipulator editing a proposed ballot 609 while it is in transit to the vote server 37 over the computer network during step 135. Threat 239 could conceivably prevent the vote server 37 from successfully generating a well-formed recorded ballot 36, and thus threatens the third election integrity guarantee 211. However, threat 239 is mitigated during either step 137 or step 139. Assuming a replay attack does not take place, in the present scenario, the vote server 37 fails to validate the well-formedness of the proposed ballot 609 during step 137 because, due to the network manipulator's actions, the voter device digital signature 607 no longer represents a valid signature of the proposed ballot 609 by the voter device 1. As a result, the vote server 37 fails to return a recorded ballot 36 to the voter device 1 and the voter device 1 thus enters the error state 511 during step 137. The third election integrity guarantee 211 is thus upheld despite the network manipulator's actions.

Network manipulators cannot successfully execute malicious replay attacks on a proposed ballot 609 during step 135. Suppose such a replay attack occurs. In the present scenario, the voter device 1 receives a recorded ballot 36 during step 135 comprising a proposed ballot 609 that does not match the proposed ballot 609 submitted by the voter device 1 during step 135. The voter device 1 will thus be unable to validate the well-formedness of said recorded ballot 36 during step 139. As a result, the voter device 1 enters an error state 511, and the third election integrity guarantee 211 is upheld despite the network manipulator's actions.

Threat 241 to the third election integrity guarantee 211 comprises a network manipulator blocking a proposed ballot 609 while it is in transit to the vote server 37 over the computer network during step 135. Threat 241 could conceivably prevent the vote server 37 from successfully generating a well-formed recorded ballot 36, and thus threatens the third election integrity guarantee 211. However, threat 241 is mitigated during step 139. In the present scenario, the voter device 1 does not receive a well-formed recorded ballot 36 from the vote server 37 because the network manipulator blocked the proposed ballot 609 from reaching the vote server 37, and thus the vote server 37 does not generate a recorded ballot 36. As a result, the voter device 1 enters the error state 511 during step 139. The third election integrity guarantee 211 is thus upheld despite the network manipulator's actions.

Threat 243 to the third election integrity guarantee 211 comprises a network manipulator editing a recorded ballot 36 while it is in transit to the voter device 1 over the computer network during step 139. Threat 243 could conceivably prevent the vote server 37 from successfully generating a well-formed recorded ballot 36, and thus threatens the third election integrity guarantee 211. However, threat 243 is mitigated during step 139. Assuming a replay attack does not take place, in the present scenario, the voter device 1 fails to validate the well-formedness of the recorded ballot 36 during step 139, because the vote server digital signature 705 no longer represents a valid signature of the recorded ballot 36 data by the vote server 37 due to the network manipulator's actions. As a result, the voter device 1 enters the error state 511 during step 139, and the third election integrity guarantee 211 is upheld despite the network manipulator's actions.

Network manipulators cannot successfully execute malicious replay attacks on a recorded ballot 36 during step 139. Suppose such a replay attack occurs. In the present scenario, the voter device 1 receives a recorded ballot 36 comprising an enclosed proposed ballot 701 that does not match the proposed ballot 609 submitted by the voter device 1 during step 135. The voter device 1 will thus be unable to validate the well-formedness of said recorded ballot 36 during step 139. As a result, the voter device 1 enters an error state 511, and the fourth election integrity guarantee 213 is upheld despite the network manipulator's actions.

Threat 245 to the third election integrity guarantee 211 comprises a network manipulator blocking a recorded ballot 36 while it is in transit to the voter device 1 over the computer network during step 139. Threat 245 could conceivably prevent the vote server 37 from successfully generating a well-formed recorded ballot 36, and thus threatens the third election integrity guarantee 211. However, threat 245 is mitigated during step 139. In the present scenario, the voter device 1 does not receive a recorded ballot 36 from the vote server 37 because the network manipulator blocked the recorded ballot 36 from reaching the voter device 1. As a result, the voter device 1 enters the error state 511 during step 139, and the third election integrity guarantee 211 is upheld despite the network manipulator's actions.

Threat 247 to the third election integrity guarantee 211 comprises a vote server 37 modifying a proposed ballot 609 prior to inclusion in the recorded ballot 36 during step 135. Threat 247 could conceivably prevent the vote server 37 from successfully returning a well-formed recorded ballot 36 to the voter device 1, and thus threatens the third election integrity guarantee 211. However, threat 247 is mitigated during step 139. In the present scenario, the voter device 1 fails to validate the well-formedness of the recorded ballot 36 during step 139, because the enclosed proposed ballot 701 does not match the proposed ballot 609 submitted to the voter server. As a result, the voter device 1 enters the error state 511, and the third election integrity guarantee 211 is upheld despite the vote server's 37 actions.

Threat 249 to the third election integrity guarantee 211 comprises a vote server 37 failing to return a recorded ballot 36 to the voter device 1 during step 139, or returning a malformed recorded ballot 36 to the voter device 1 during step 139. Threat 249 could conceivably prevent the vote server 37 from successfully returning a well-formed recorded ballot 36 to the voter device 1, and thus threatens the third election integrity guarantee 211. However, threat 249 is mitigated during step 139. In the present scenario, the voter device 1 fails to validate the well-formedness of the recorded ballot 36 during step 139, because the voter device 1 either did not receive a recorded ballot 36 or received a malformed recorded ballot 36. As a result, the voter device 1 enters the error state 511, and the third election integrity guarantee 211 is upheld despite the vote server's 37 actions.

FIG. 2E depicts the security threats that threaten the fourth election integrity guarantee 213. Threat 251 to the fourth election integrity guarantee 213 comprises a network manipulator editing a recorded ballot 36 while it is in transit to an honest audit server 45 over the computer network during step 143. Threat 251 could conceivably prevent the voter device 1 from successfully transmitting its recorded ballot 36 to honest audit servers 45, and thus threatens the fourth election integrity guarantee 213. However, threat 251 is mitigated during step 147. In the present scenario, the honest audit server 45 fails to validate the well-formedness of the recorded ballot 36 during step 145, because the vote server digital signature 705 no longer represents a valid signature of the recorded ballot 36 by the vote server 37 due to the network manipulator's actions. As a result, the audit server 45 returns an error to the voter device 1 and the voter device 1 enters the error state 511 during step 147. The fourth election integrity guarantee 213 is thus upheld despite the network manipulator's actions.

Threat 253 to the fourth election integrity guarantee 213 comprises a network manipulator blocking a recorded ballot 36 while it is in transit to an honest audit server 45 over the computer network during step 143. Threat 253 could conceivably prevent the voter device 1 from successfully transmitting its recorded ballot 36 to honest audit servers 45, and thus threatens the fourth election integrity guarantee 213. However, threat 253 is mitigated during step 147. In the present scenario, the voter device 1 does not receive an audit server ballot submission success response 1801 from the audit server 45 because the network manipulator blocked the recorded ballot 36 from reaching the audit server 45. As a result, the voter device 1 enters the error state 511 during step 147, and the fourth election integrity guarantee 213 is upheld despite the network manipulator's actions.

Threat 255 to the fourth election integrity guarantee 213 comprises a network manipulator editing an audit server response while it is in transit to a voter device 1 over the computer network during step 145. Specifically, threat 255 comprises a network manipulator falsifying an audit server ballot submission success response 1801. Threat 255 could conceivably prevent the voter device 1 from entering the error state 511 when the recorded ballot 36 has not been successfully transmitted to the audit server 45, and threat 255 thus threatens the fourth election integrity guarantee 213. However, threat 255 is mitigated during step 147. Assuming a replay attack does not take place, in the present scenario, the voter device 1 fails to validate the well-formedness of the audit server ballot submission success response 1801 during step 147. The audit server ballot submission success response 1801 is malformed because the audit server 45 did not generate the audit server ballot submission success response 1801, and thus the audit server digital signature 1807 does not reflect a valid digital signature of the audit server ballot submission success response 1801 by the audit server 45. As a result, the voter device 1 enters the error state 511 during step 147, and the fourth election integrity guarantee 213 is upheld despite the network manipulator's actions.

Network manipulators cannot successfully execute malicious replay attacks on an audit server ballot submission success response 1801 during step 145. The audit server ballot submission success response 1801 comprises an enclosed recorded ballot 1803. When the voter device 1 validates the well-formedness of the audit server ballot submission success response 1801 during step 147, the voter device 1 validates that the enclosed recorded ballot 1803 matches the recorded ballot 36 submitted by the voter device 1 during step 143. If a network manipulator attempts to execute a replay attack, said validation fails, the voter device 1 enters an error state 511 during step 147, and the fourth election integrity guarantee 213 is upheld despite the network manipulator's actions.

Threat 257 to the fourth election integrity guarantee 213 comprises a network manipulator blocking a audit server ballot submission success response 1801 or error while it is in transit to a voter device 1 over the computer network during step 145. Threat 257 could conceivably prevent the voter device 1 from entering the error state 511 when the recorded ballot 36 has not been successfully transmitted to the audit server 45, and threat 257 thus threatens the fourth election integrity guarantee 213. However, threat 257 is mitigated during step 147. In the present scenario, the voter device 1 does not receive an audit server ballot submission success response 1801 and thus enters the error state 511 during step 147. The fourth election integrity guarantee 213 is thus upheld despite the network manipulator's actions.

FIG. 2F depicts the security threats 219b that threaten the fifth election integrity guarantee 215. Threat 259 to the fifth election integrity guarantee 215 comprises a network manipulator editing the signed binary merkle tree 49 or tally 51 while it is in transit to the public repository 47 over the computer network during step 155. Threat 259 could conceivably interrupt the publishing of a well-formed signed binary merkle tree 49 or a well-formed tally 51, and thus threatens the fifth election integrity guarantee 215. However, threat 259 is handled during step 155. Assuming a replay attack does not take place, the present scenario, if the signed binary merkle tree 49 is edited by a network manipulator, the public repository 47 fails to validate the well-formedness of the signed binary merkle tree 49 during step 155, because the vote server digital signature 801 no longer represents a valid digital signature of the signed binary merkle tree 49 by the vote server 37. As a result, the public repository 47 returns an error and the vote server 37 raises an alarm during step 155. The fifth election integrity guarantee 215 is thus upheld despite the network manipulator's actions. Likewise, if the tally 51 is edited by a network manipulator, the public repository 47 fails to validate the well-formedness of the tally 51 during step 155, because the vote server digital signature 1907 no longer represents a valid digital signature of the tally 51 by the vote server 37 (again assuming a replay attack does not take place). As a result, the public repository 47 returns an error and the vote server 37 raises an alarm during step 155. The fifth election integrity guarantee 215 is thus upheld despite the network manipulator's actions.

Network manipulators cannot successfully execute malicious replay attacks on a signed binary merkle tree 49 or tally 51 during step 155. Suppose such a replay attack occurs. In the present scenario, the public repository 47 returns a public repository success response 2001 comprising a signed binary merkle tree 49 and/or tally 51 that does not match the signed binary merkle tree 49 and/or tally 51 submitted by the vote server 37 during step 155. The vote server 37 will thus be unable to validate the well-formedness of said public repository success response 2001 during step 155. As a result, the vote server 37 raises an alarm during step 155, and the fifth election integrity guarantee 215 is upheld despite the network manipulator's actions.

Threat 261 to the fifth election integrity guarantee 215 comprises a network manipulator blocking the signed binary merkle tree 49 or tally 51 while it is in transit to the public repository 47 over the computer network during step 155. Threat 261 could conceivably interrupt the publishing of a well-formed signed binary merkle tree 49 or a well-formed tally 51, and thus threatens the fifth election integrity guarantee 215. However, threat 261 is mitigated during step 155. In the present scenario, the public repository 47 does not receive a well-formed signed binary merkle tree 49 and tally 51 and thus does not return a public repository success response 2001 to the vote server 37. As a result, the vote server 37 raises an alarm during step 155. The fifth election integrity guarantee 215 is thus upheld despite the network manipulator's actions.

Threat 263 to the fifth election integrity guarantee 215 comprises a network manipulator editing a public repository response while it is in transit to the vote server 37 over the computer network during step 155. Specifically, threat 263 comprises a network manipulator falsifying a public repository success response 2001. Threat 263 could conceivably prevent the vote server 37 from recognizing when the signed binary merkle tree 49 and tally 51 has not been successfully transmitted to the public repository 47, and thus threatens the fifth election integrity guarantee 215. However, threat 263 is mitigated during step 155. Assuming a replay attack does not take place, in the present scenario, the vote server 37 fails to validate the well-formedness of the public repository success response 2001 during step 155; the public repository success response 2001 is malformed because the public repository 47 did not generate the public repository success response 2001 and thus the public repository digital signature 2007 does not reflect a valid digital signature of the public repository success response 2001 by the public repository 47. As a result, the vote server 37 raises an alarm during step 155. The fifth election integrity guarantee 215 is thus upheld despite the network manipulator's actions.

Network manipulators cannot successfully execute malicious replay attacks on a public repository success response 2001 during step 155. Suppose such a replay attack occurs. In the present scenario, the vote server 37 receives a public repository success response 2001 comprising a signed binary merkle tree 49 and/or tally 51 that does not match the signed binary merkle tree 49 and/or tally 51 submitted by the vote server 37 during step 155. The vote server 37 will thus be unable to validate the well-formedness of said public repository success response 2001 during step 155. As a result, the vote server 37 raises an alarm during step 155, and the fifth election integrity guarantee 215 is upheld despite the network manipulator's actions.

Threat 265 to the fifth election integrity guarantee 215 comprises a network manipulator blocking a public repository response while it is in transit to the vote server 37 over the computer network during step 155. Threat 265 could conceivably prevent the vote server 37 from recognizing when the signed binary merkle tree 49 and tally 51 has not been successfully transmitted to the public repository 47, and thus threatens the fifth election integrity guarantee 215. However, threat 265 is handled during step 155. In the present scenario, the vote server 37 does not receive a public repository success response 2001 and thus raises an alarm during step 155. The fifth election integrity guarantee 215 is upheld despite the network manipulator's actions.

Threat 267 to the fifth election integrity guarantee 215 comprises a network manipulator editing the public repository election result response 1401 while it is in transit to an audit server 45 over the computer network during step 159. Threat 267 could conceivably prevent the audit server 45 from recognizing when a signed binary merkle tree 49 or tally 51 does not meet the criteria set in the fifth election integrity guarantee 215. However, threat 267 is mitigated during step 159. Assuming a replay attack does not take place, in the present scenario, the audit server 45 fails to validate the well-formedness of the public repository election result response 1401 during step 159, because the public repository digital signature 1405 no longer represents a valid digital signature of the public repository election result response 1401 by the public repository 47. As a result, the audit server 45 raises an alarm during step 159. The fifth election integrity guarantee 215 is thus upheld despite the network manipulator's actions.

Network manipulators cannot successfully execute malicious replay attacks on a public repository election result response 1401 during step 159. Such a replay attack would require multiple versions of the public repository election result response 1401, such that a network manipulator can swap one version of the public repository election result response 1401 for another version of same. In each instance of the election system 1601, however, the public repository 47 only allows for a single mutation, and thus the public repository 47 only ever returns a single version of the public repository election result response 1401 during step 159. Thus, replay attacks are only possible if a network manipulator causes an audit server 45 to receive a public repository election result response 1401 from a different instance of the election system 1601. However, each instance of the election system 1601 comprises different cryptographic keys 21a, 21b, 17a, 17b, 19a, 19b, 41a, and 41b, and thus a public repository election result response 1401 from one instance of the election system 1601 is not well-formed for a different instance of the election system 1601. Thus, in the present scenario, the audit server 45 fails to validate the well-formedness of the public repository election result response 1401 and raises an alarm during step 159. The fifth election integrity guarantee 215 is thus upheld despite the network manipulator's actions.

Threat 269 to the fifth election integrity guarantee 215 comprises a network manipulator blocking the public repository election result response 1401 while it is in transit to an audit server 45 over the computer network during step 159. Threat 269 could conceivably prevent the audit server 45 from recognizing when a signed binary merkle tree 49 or tally 51 does not meet the criteria set in the fifth election integrity guarantee 215. However, threat 269 is handled during step 159. In the present scenario, the audit server 45 does not receive a well-formed public repository election result response 1401 and thus raises an alarm during step 159. The fifth election integrity guarantee 215 is upheld despite the network manipulator's actions.

Threat 271 to the fifth election integrity guarantee 215 comprises the vote server 37 publishing a signed binary merkle tree 49 during step 155 that either does not comprise enclosed recorded ballots 1203 for all well-formed recorded ballots 36 that were successfully cast during the ballot casting stage 173, or includes additional enclosed recorded ballots 1203 that were not successfully cast during the ballot casting stage 173. Threat 271 could conceivably result in the published signed binary merkle tree 49 not meeting the criteria set in the fifth election integrity guarantee 215. However, threat 271 is mitigated during step 159. In the present scenario, the vote server 37 is dishonest; thus, at least one audit server 45 is honest per assumption 203. The at least one honest audit server 45 recognizes during step 159 that the enclosed recorded ballots 1203 contained in the binary merkle tree 805 do not exactly match the recorded ballots 36 saved in said audit server's 45 memory 2305, 2307. The at least one audit server 45 thus raises an alarm during step 159. The fifth election integrity guarantee 215 is thus upheld despite the vote server's 37 actions.

Threat 273 to the fifth election integrity guarantee 215 comprises the vote server 37 publishing a tally 51 during step 155 with candidate vote counts 1906 that do not accurately reflect the tally of well-formed recorded ballots 36 that were successfully cast during the ballot casting stage 173. Threat 273 could conceivably result in the published tally 51 not meeting the criteria set in the fifth election integrity guarantee 215. However, threat 273 is mitigated during step 159. In the present scenario, the vote server 37 is dishonest; thus, at least one audit server 45 is honest per assumption 203. The at least one honest audit server 45 generates its own tally 51 during step 159 using the recorded ballots 36 in said audit server's 45 memory 2305, 2307. The at least one honest audit server 45 then recognizes that the tally 51 generated by said audit server 45 does not match the tally 51 published by the vote server 37, and thus raises an alarm. The fifth election integrity guarantee 215 is thus upheld despite the vote server's 37 actions.

Threat 275 to the fifth election integrity guarantee 215 comprises the vote server 37 refusing to generate and publish a signed binary merkle tree 49 and/or tally 51 during step 155. Threat 275 could conceivably interrupt the publishing of a well-formed signed binary merkle tree 49 or a well-formed tally 51, and thus threatens the fifth election integrity guarantee 215. However, threat 275 is mitigated during step 159. In the present scenario, the vote server 37 is dishonest; thus, at least one audit server 45 is honest per assumption 203. The at least one honest audit server 45 fails to retrieve a signed binary merkle tree 49 and/or tally 51 from the public repository 47 during step 159 and thus raises an alarm. The fifth election integrity guarantee 215 is thus upheld despite the network manipulator's actions.

Threat 277 to the fifth election integrity guarantee 215 comprises the vote server 37 publishing a malformed signed binary merkle tree 49 and/or tally 51 during step 155. Threat 277 could conceivably interrupt the publishing of a well-formed signed binary merkle tree 49 or a well-formed tally 51, and thus threatens the fifth election integrity guarantee 215. However, threat 277 is mitigated during step 159. In the present scenario, the vote server 37 is dishonest; thus, at least one audit server 45 is honest per assumption 203. The at least one honest audit server 45 fails to retrieve a well-formed signed binary merkle tree 49 and/or a well-formed tally 51 from the public repository 47 during step 159 and thus raises an alarm. The fifth election integrity guarantee 215 is thus upheld despite the network manipulator's actions.

Threat 279 to the fifth election integrity guarantee 215 comprises an audit server 45 failing to raise an alarm when it should do so during step 159. Threat 279 could conceivably prevent an alarm from being raised when a signed binary merkle tree 49 or tally 51 does not meet the criteria set in the fifth election integrity guarantee 215. However, threat 279 is mitigated during step 159. In the present scenario, an audit server 45 is dishonest; per assumption 203, the vote server 37 or at least one other audit server 45 is honest. If the vote server 37 is honest, the vote server 37 generates an accurate signed binary merkle tree 49 and tally 51, and thus the fifth election integrity guarantee 215 is upheld. If the vote server 37 is dishonest, at least one audit server is honest. The at least one honest audit server 45 follows the election method 169 faithfully, and thus raises an alarm during step 159 when the dishonest audit server 45 did not. The fifth election integrity guarantee 215 is thus upheld despite the dishonest audit server's 45 actions.

Threat 281 to the fifth election integrity guarantee 215 comprises an vote server 37 failing to raise an alarm when it should do so during step 155. Threat 281 could conceivably prevent an alarm from being raised when a signed binary merkle tree 49 or tally 51 does not meet the criteria set in the fifth election integrity guarantee 215. However, threat 281 is mitigated during step 159. In the present scenario, the vote server 37 is dishonest; per assumption 203, at least one audit server 45 is honest. The vote server 37 only ought to raise an alarm if the vote server 37 fails to publish a well-formed signed binary merkle tree 49 and/or a well-formed tally 51. If the vote server 37 truly fails to publish a well-formed signed binary merkle tree 49 and/or a well-formed tally 51 and yet does not raise an alarm, an honest audit server 45 raises an alarm during step 159 because the audit server 45 does not receive a well-formed signed binary merkle tree 49 and tally 51 from the public repository 47. The fifth election integrity guarantee 215 is thus upheld despite the dishonest vote server's 37 actions.

FIG. 2G depicts the security threats 219b that threaten the sixth election integrity guarantee 217. Threat 283 to the sixth election integrity guarantee 217 comprises a network manipulator editing a signed partial binary merkle tree 1007 while it is in transit to a voter device 1 over the computer network during step 161. Threat 283 could conceivably prevent the voter device 1 from recognizing that its recorded ballot 36 has not been included in the signed binary merkle tree 49, and thus threat 283 threatens the sixth election integrity guarantee 217. However, threat 283 is mitigated during step 161 or step 163. In the present scenario, the voter device 1 either fails to validate the well-formedness of the signed partial binary merkle tree 1007 during step 161, or fails to perform the partial binary merkle tree validation steps during step 163. In most embodiments of the present scenario, the signed partial binary merkle tree 1007 is malformed because, due to the network manipulator's actions, the digital signature 1001 no longer represents a valid signature of the signed partial binary merkle tree 1007 by the audit server 45 or vote server 37 that returned the signed partial binary merkle tree 1007. If the signed partial binary merkle tree 1007 is malformed in said manner, the voter device 1 enters the error state 511 during step 161, and the sixth election integrity guarantee 217 is upheld despite the network manipulator's actions. The signed partial binary merkle tree 1007 will always be malformed in said manner unless the network manipulator performs a replay attack.

To perform a replay attack during step 161, a network manipulator first intercepts a signed partial binary merkle tree 1007 that is returned to a first voter device 1 by the vote server 37 or an audit server 45 over the computer network during step 161. Then, the network manipulator replaces the signed partial binary merkle tree 1007 (first signed partial binary merkle tree 1007) with a different signed partial binary merkle tree 1007 that was previously returned to a second voter device 1 by the same vote server 37 or audit server 45 (second signed partial binary merkle tree 1007). The network manipulator then sends the first voter device 1 the second signed partial binary merkle tree 1007. In the present scenario, the second signed partial binary merkle tree 1007 does not contain a partial binary merkle tree node 1003 with the first voter device's 1 recorded ballot 36, because the second signed partial binary merkle tree 1007 was not generated for the first voter device 1. The first voter device 1 thus fails to perform the partial binary merkle tree validation steps during step 163 and enters an error state 511. The sixth election integrity guarantee 217 is thus upheld despite the network manipulator's actions.

A network manipulator may also attempt to perform a replay attack during step 161 by returning a signed partial binary merkle tree 1007 created in a different instance of the election system 1601. However, each instance of the election system 1601 comprises different cryptographic keys 21a, 21b, 17a, 17b, 19a, 19b, 41a, and 41b, and thus a signed partial binary merkle tree 1007 from one instance of the election system 1601 is not well-formed for a different instance of the election system 1601. Thus, in the present scenario, the voter device 1 fails to validate the well-formedness of the signed partial binary merkle tree 1007 and enters an error state 511 during step 161.

Threat 285 to the sixth election integrity guarantee 217 comprises a network manipulator blocking a signed partial binary merkle tree 1007 while it is in transit to a voter device 1 over a computer network during step 161. Threat 285 could conceivably prevent the voter device 1 from recognizing that its recorded ballot 36 has not been included in the signed binary merkle tree 49, and thus threat 285 threatens the sixth election integrity guarantee 217. However, threat 285 is mitigated during step 161. In the present scenario, the voter device 1 fails to validate the well-formedness of the signed partial binary merkle tree 1007 during step 161, because the voter device 1 did not receive a signed partial binary merkle tree 1007. As a result, the voter device 1 enters the error state 511 during step 161. The sixth election integrity guarantee 217 is thus upheld despite the network manipulator's actions.

Threat 287 to the sixth election integrity guarantee 217 comprises the vote server 37 failing to publish a well-formed signed binary merkle tree 49 during step 155. Threat 287 could conceivably interrupt the publishing of a signed binary merkle tree 49 that meets the sixth election integrity guarantee 217. However, threat 287 is mitigated during step 161. In the present scenario, the vote server 37 is dishonest; thus, at least one audit server 45 is honest. When the voter device 1 requests signed partial binary merkle trees 1007 from the at least one audit server 45 during step 161, said audit server 45 returns an error because no signed binary merkle tree 49 was published and the audit server 45 thus cannot generate a signed partial binary merkle tree 1007. As a result, the voter device 1 enters the error state 511 during step 161. The sixth election integrity guarantee 217 is thus upheld despite the vote server's 37 actions.

Threat 289 to the sixth election integrity guarantee 217 comprises the vote server 37 failing to include a voter device's 1 recorded ballot as an enclosed recorded ballot 1203 of a binary merkle tree node 803 of the binary merkle tree 805 during step 155. Threat 289 could conceivably interrupt the publishing of a signed binary merkle tree 49 that meets the sixth election integrity guarantee 217. However, threat 289 is mitigated during step 161. In the present scenario, the vote server 37 is dishonest; thus, at least one audit server 45 is honest. When the voter device 1 requests signed partial binary merkle trees 1007 from the at least one audit server 45 during step 161, the audit server 45 returns an error because the signed binary merkle tree 49 does not contain an enclosed recorded ballot 1203 that corresponds to the voter device's 1 recorded ballot 36 and thus the partial binary merkle tree generation method 1101 cannot be completed. As a result, the voter device 1 enters the error state 511 during step 161. The sixth election integrity guarantee 217 is thus upheld despite the vote server's 37 actions.

Threat 291 to the sixth election integrity guarantee 217 comprises a network manipulator preventing an audit server 45 from obtaining a well-formed signed binary merkle tree 49 during step 159 via any of the pertinent security threats 219b that were previously discussed. Threat 291 could conceivably prevent the audit server 45 from returning a signed partial binary merkle tree 1007 to a voter device 1, thus preventing said voter device 1 from completing the partial binary merkle tree audit steps. Thus, threat 291 threatens the sixth election integrity guarantee 217. However, threat 291 is mitigated during step 161. In the present scenario, the affected audit server 45 does not obtain a well-formed signed binary merkle tree 49 and thus cannot generate signed partial binary merkle trees 1007. The audit server 45 thus returns an error when the voter device 1 requests a signed partial binary merkle tree 1007 during step 161. The voter device 1 thus enters the error state 511, and the sixth election integrity guarantee 217 is upheld despite the network manipulator's actions.

Threat 293 to the sixth election integrity guarantee 217 comprises a vote server 37 returning a misleading signed partial binary merkle tree 1007 to a voter device 1 during step 161. A misleading signed partial binary merkle tree 1007 comprises a partial binary merkle tree 1005 that does not represent the true output of the partial binary merkle tree generation method 1101 applied to the binary merkle tree 805 of the published signed binary merkle tree 49. Threat 293 could conceivably prevent the voter device 1 from recognizing that its recorded ballot 36 has not been included in the signed binary merkle tree 49, and thus threat 293 threatens the sixth election integrity guarantee 217. However, threat 293 is mitigated during step 163. In the present scenario, the vote server 37 is dishonest, and thus at least one audit server 45 is honest per assumption 203. When the voter device 1 requests a signed partial binary merkle tree 1007 from the at least one honest audit server 45 during step 161, the at least one honest audit server 45 returns a signed partial binary merkle tree 1007 with a partial binary merkle tree 1005 that represents the true output of the partial binary merkle tree generation method 1101 applied to the binary merkle tree 805 of the published signed binary merkle tree 49, or returns an error if the partial binary merkle tree generation method 1101 cannot be completed. It follows that the voter device 1 receives either an error, or at least two differing partial binary merkle trees 1005 in the present scenario. Thus, the voter device 1 enters the error state 511 during step 163. The sixth election integrity guarantee 217 is thus upheld despite the vote server's 37 actions.

Threat 295 to the sixth election integrity guarantee 217 comprises a vote server 37 failing to return a signed partial binary merkle tree 1007 to a voter device 1 during step 161, or returning a malformed signed partial binary merkle tree 1007. Threat 295 could conceivably prevent the voter device 1 from recognizing that its recorded ballot 36 has not been included in the signed binary merkle tree 49, and thus threat 295 threatens the sixth election integrity guarantee 217. However, threat 295 is mitigated during step 161. In the present scenario, the voter device 1 does not receive a well-formed signed partial binary merkle tree 1007 from the vote server 37 and thus enters the error state 511 during step 161. The sixth election integrity guarantee 217 is thus upheld despite the vote servers 37 actions.

Threat 297 to the sixth election integrity guarantee 217 comprises an audit server 45 returning a misleading signed partial binary merkle tree 1007 to a voter device 1 during step 161. A misleading signed partial binary merkle tree 1007 comprises a partial binary merkle tree 1005 that does not represent the true output of the partial binary merkle tree generation method 1101 applied to the binary merkle tree 805 of the published signed binary merkle tree 49. Threat 297 could conceivably prevent the voter device 1 from recognizing that its recorded ballot 36 has not been included in the signed binary merkle tree 49, and thus threat 297 threatens the sixth election integrity guarantee 217. However, threat 297 is mitigated during step 163. In the present scenario, the audit server 45 is dishonest, and thus the vote server 37 or at least one audit server 45 is honest per assumption 203. When the voter device 1 requests a signed partial binary merkle tree 1007 from said honest vote server 37 or said honest audit server 45 during step 1a, said honest vote server 37 or said honest audit server 45 returns a signed partial binary merkle tree 1007 with a partial binary merkle tree 1005 that represents the true output of the partial binary merkle tree generation method 1101 applied to the published binary merkle tree 805 of the signed binary merkle tree 49, or returns an error if the partial binary merkle tree generation method 1101 cannot be completed. It follows that the voter device 1 receives either an error, or at least two differing partial binary merkle trees 1005 in the present scenario. Thus, the voter device 1 enters the error state 511 during step 163. The sixth election integrity guarantee 217 is thus upheld despite the audit server's 45 actions.

Threat 299 to the sixth election integrity guarantee 217 comprises an audit server 45 failing to return a signed partial binary merkle tree 1007 to a voter device 1 during step 161, or returning a malformed signed partial binary merkle tree 1007. Threat 299 could conceivably prevent the voter device 1 from recognizing that its recorded ballot 36 has not been included in the signed binary merkle tree 49, and thus threat 299 threatens the sixth election integrity guarantee 217. However, threat 299 is mitigated during step 161. In the present scenario, the voter device 1 does not receive a well-formed signed partial binary merkle tree 1007 from the audit server 45 and thus enters the error state 511 during step 161. The sixth election integrity guarantee 217 is thus upheld despite the audit server's 45 actions.

Assumption 201 assumes that voter devices 1 are honest. In alternative embodiments, assumption 201 can be partially or entirely removed via the use of publicly-accessible terminals attached to audit servers 45 and/or vote servers 37. These terminals allow each voter to verify that the candidate choices 603 electronically submitted by the voter device 1 during the ballot casting stage 173 exactly match the candidate choices 603 inputted by the voter during the candidate prompt substage 129. This verification can occur independently from the voter device 1, thus providing a failsafe mechanism to identify and mitigate dishonest voter device 1 behavior.

The publicly-accessible terminals may also provide other verification functionality. For example, the publicly-accessible terminals may display the hash 1207 of the published signed binary merkle tree's 49 binary merkle tree root node 807, such that each voter can compare said hash 1207 against the hash 1207 of the partial binary merkle tree root node 1209 received by the voter device 1 during the voter device audit stage 177. If said hashes 1207 match for a given voter, the voter can be further assured that the election results 49, 51 truly contains the voter's candidate choices 603.

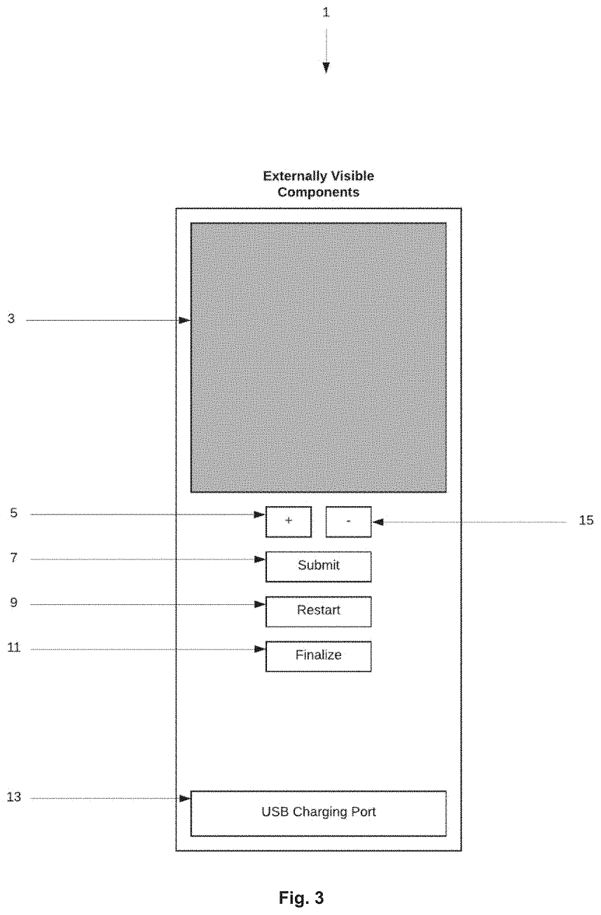

FIG. 3 depicts a first embodiment of the voter device 1. The voter device 1 comprises a digital display 3, one or more buttons 5, 7, 9, 11, and 15, and a USB charging port 13. Voters interact with their voter device 1 using the buttons 5, 7, 9, 11, and 15 and digital display 3. Alternative embodiments of the voter device 1 may comprise alternative components that facilitate interaction with the voter, such as a speaker, microphone, or any other components that allow for efficient voter interaction. Alternative embodiments of the voter device may be accessible to disabled voters. The voter device may be implemented in full or in part by a computer system 2301.

FIG. 4 depicts a first embodiment of the voter device manufacturing method 415. The voter device manufacturing method 415 comprises three stages: the assembly stage 401, the configuration stage 403, and the delivery stage 405. The assembly stage 401 comprises the voter device 1 being assembled in a factory or other assembly location. The configuration stage 403 comprises an election administrator assigning the voter device 1 to a specific voter, then loading one or more configuration settings to the voter device's 1 memory 2305, 2307. The configuration settings comprise a voter device private key 17a, a voter device public key 17b, a voter device identification number 27, the audit server public key 21b of each audit server 45, the vote server public key 19b, a set of audit server network identifiers 25, a vote server network identifier 23, and a set of computer program instructions 413. The audit server network identifiers 25 and vote server network identifier 23 are used by the voter device 1 to locate and communicate with audit servers 45 and the vote server 37 over the computer network. In the first embodiment, the network identifiers 23, 25 comprise Internet Protocol (IP) addresses. In alternative embodiments, the network identifiers 23, 25 may comprise domain names, Media Access Control (MAC) addresses, or any other identifiers that allow the voter device 1 to locate and communicate with audit servers 45 and the vote server 37 over the computer network. The computer program instructions 413 are configured such that, after the voter device 1 powers on, the voter device 1 executes the election method 169 by running the computer program instructions 413. The device delivery stage 405 comprises an election administrator packaging the voter device 1 in a crush-proof container 407 along with one or more accessories 409, 411, then delivering the package to the voter. In the first embodiment, the accessories 409, 411 comprise a device manual 409 and a USB charging cable 411.

The voter device private key 17a is mathematically associated with the voter device public key 17b such that digital signatures generated with the voter device private key 17a can be validated with the voter device public key 17b. The vote server private key 19a is mathematically associated with the vote server public key 19b such that digital signatures generated with the vote server private key 19a can be validated with the vote server public key 19b.

Each audit server 45 has a unique audit server private key 21a that is mathematically associated with a corresponding audit server public key 21b such that digital signatures generated with the audit server private key 21a can be validated with the corresponding audit server public key 21b. When the voter device 1 validates an audit server digital signature returned by an audit server 45, the voter device 1 uses the audit server public key 21b associated with said audit server's 45 audit server private key 21a to perform said digital signature validation.

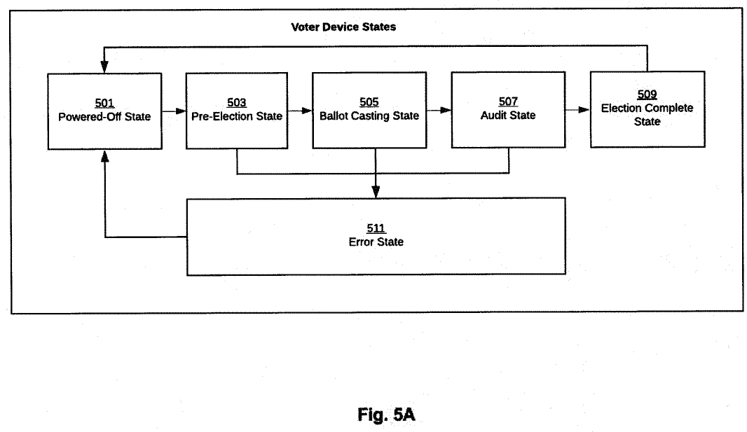

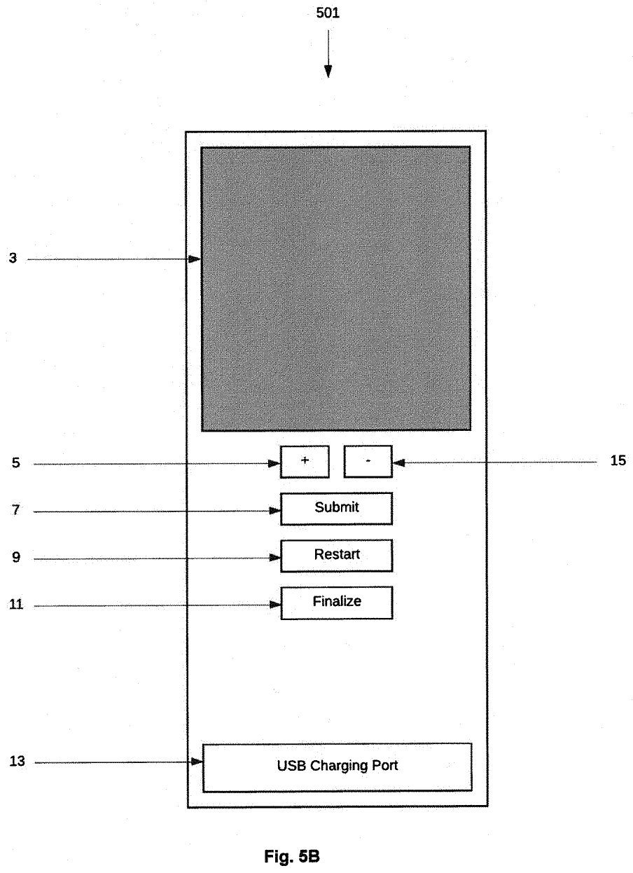

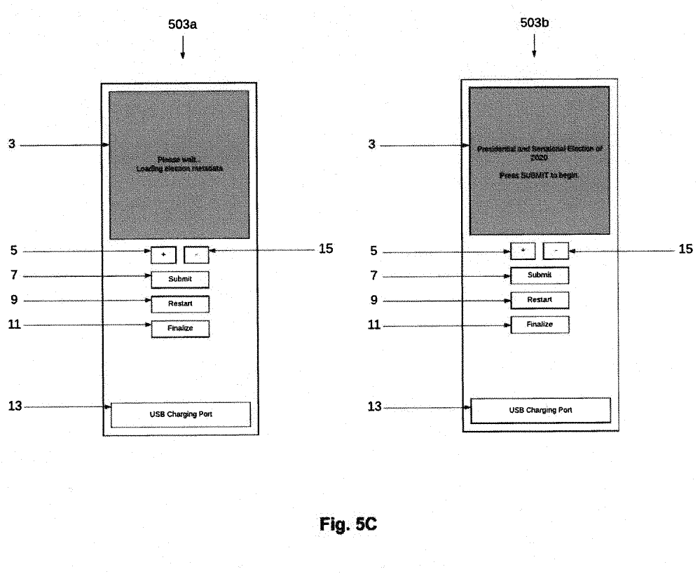

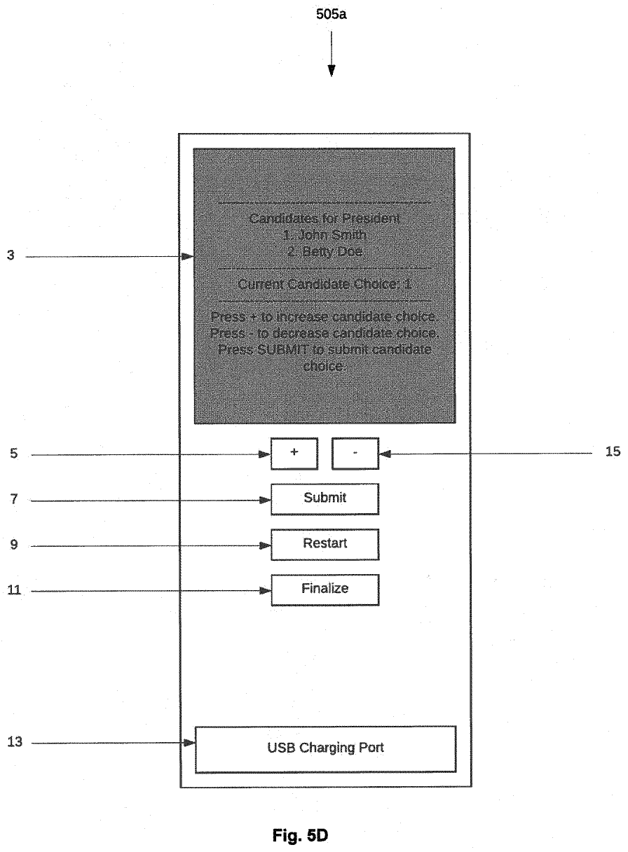

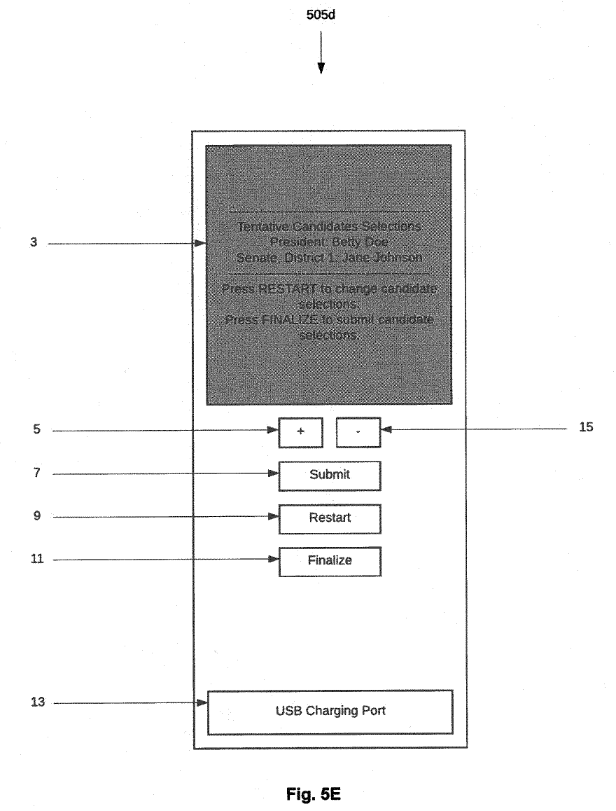

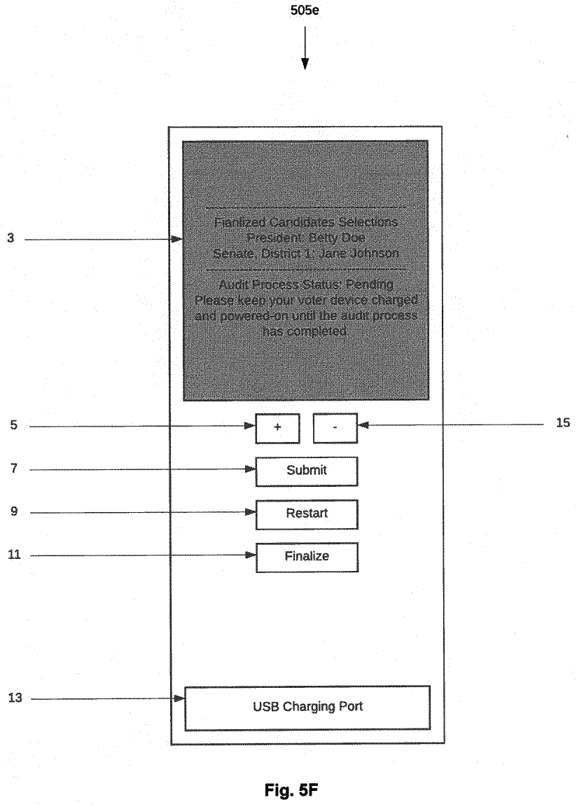

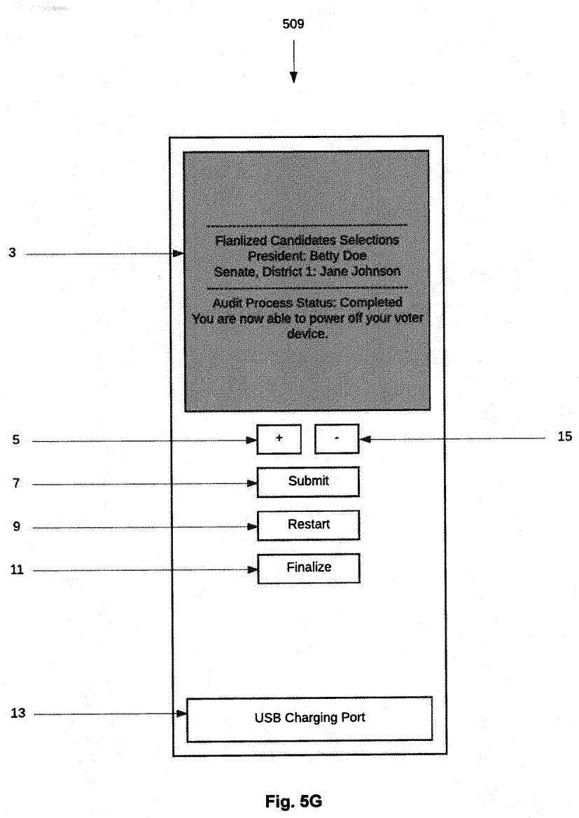

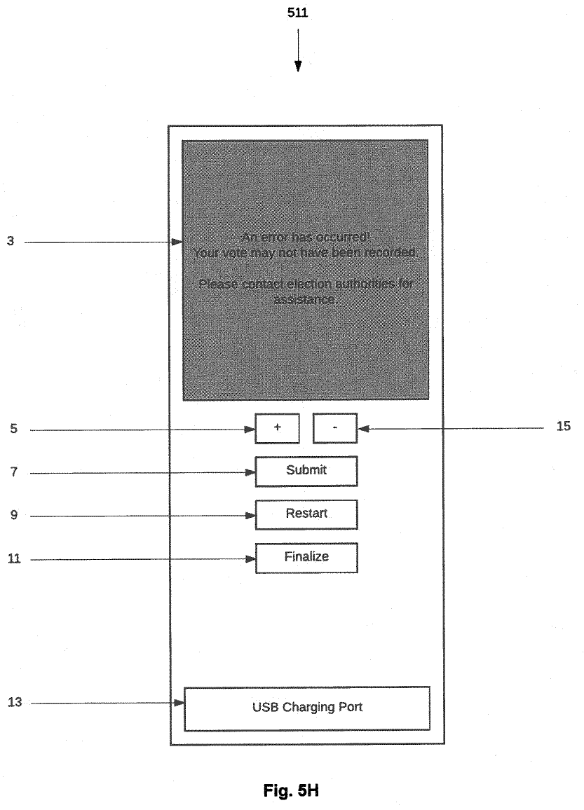

FIG. 5A depicts the various states of the first embodiment of the voter device 1. Voter devices 1 are delivered to voters in the powered-off state 501. When a voter powers on their voter device 1, the voter device 1 immediately proceeds to the pre-election state 503 and executes the pre-election stage 171 of the election method 169. If the pre-election stage 171 calls for the voter device 1 to enter the error state 511, the voter device 1 then proceeds to the error state 511. If the pre-election stage 171 calls for the voter device 1 to execute the voter device audit stage 177, the voter device enters the audit state 507, after waiting for polls to close if needed. If the pre-election stage 171 calls for the voter device 1 to execute the ballot casting stage 173, the voter device 1 proceeds to the ballot casting state 505.

If the voter device 1 enters the ballot casting state 505, the voter device 1 executes the ballot casting stage 173. If the ballot casting stage 173 calls for the voter device 1 to enter the error state 511, the voter device 1 then proceeds to the error state 511. Otherwise, the voter device 1 proceeds to the audit state 507.

When the voter device 1 enters the audit state 507, the voter device 1 executes the voter device audit stage 177. The audit state 507 is not visible to the voter; the voter device audit stage 177 is executed in the background, and the voter device 1 does not alert the voter of this process until the audit state 507 completes. If the voter device audit stage 177 calls for the voter device 1 to enter the error state 511, the voter device 1 then proceeds to the error state 511; otherwise, the voter device 1 proceeds to the election complete state 509 and executes the election complete stage 179 of the election method 169. Once the voter device 1 enters the election complete state 509 or error state 511, the voter can move their voter device 1 back into the powered-off state 501 by pressing and holding the submit button 7 and the finalize button 11 simultaneously for several seconds.

FIG. 5B depicts the first embodiment of the voter device 1 in the powered-off state 501. While the voter device is in the powered-off state 501, the voter can power on the voter device 1 by pressing and holding the submit button 7 and the finalize button 11 simultaneously for several seconds.

FIG. 5C depicts the first embodiment of the voter device 1 in the pre-election state 503. The pre-election state comprises a first substrate 503a and a second substrate 503b. The voter device 1 enters the first substrate 503a immediately after powering on, and remains in the first substrate 503a until the voter device 1 completes the pre-election stage 171 of the election method 169. Once the voter device 1 completes the pre-election stage 171 of the election method 169, the voter device 1 enters either the error state 511, the audit state 507, or the second substrate 503b. When the voter device is in the second substrate 503b, the voter can move the voter device 1 into the ballot casting state 505 by pressing the submit button 7.

FIG. 5D depicts the first embodiment of the voter device 1 in the first substrate 505a of the ballot casting state 505. Upon entering the ballot casting state 505, the voter device 1 immediately enters the first substrate 505a. While the voter device 1 is in the first substrate 505a, the voter device 1 presents the voter with the list of valid candidates for the first sub-election 1707 as well as a current candidate selection. The voter modifies their current candidate selection by pressing a plus button 5 and a minus button 15 located directly above the submit button 7. Pressing the plus button 5 increases the current candidate selection by one; pressing the minus button 15 decreases the current candidate selection by one. Once the voter has selected their desired candidate for the first sub-election 1905, the voter presses the submit button 7. The voter device 1 then determines whether the voter has selected candidates for all sub-elections 1905. If the voter has not selected candidates for all sub-elections 1905, the voter device 1 continues executing the candidate prompt substage 129 by prompting the voter to select candidates for the remaining sub-elections 1905. The voter device 1 may prompt the voter to select candidates for any number of sub-elections 1905 before completing the candidate prompt substage 129. Once the voter has selected candidates for all sub-elections 1905, the voter device 1 proceeds to enter the second substrate 505d of the ballot casting state 505.

FIG. 5E depicts the first embodiment of the voter device 1 in the second substrate 505d of the ballot casting state 505. While the voter device 1 is in the second substrate 505d, the voter device 1 prompts the voter to confirm their candidate selections. Once the voter confirms their candidate selections, the voter device continues executing the ballot casting stage 173. Once the voter device 1 reaches the wait for tally substage 149 of the ballot casting stage 173, the voter device 1 enters the third substrate 505e and remains in the third substrate 505e until the wait for tally substage 149 completes.

FIG. 5F depicts the first embodiment of the voter device 1 in the third substrate 505e of the ballot casting state 505. While the voter device 1 is in the second substrate 505e, the voter device 1 prompts to voter to keep their voter device 1 powered on.

FIG. 5G depicts the first embodiment of the voter device 1 in the election complete state 509. The voter is reassured that they have completed the election method 169 and can power off the voter device 1.

FIG. 5H depicts the first embodiment of the voter device 1 in the error state 511. The voter is instructed to contact election authorities for assistance.

FIG. 6 depicts a first embodiment of the proposed ballot 609. A well-formed proposed ballot 609 comprises a voter device identification number 601 (which is an embodiment of the voter device identification number 27), a list of candidate choices 603 for each sub-election 1905, a finalized-at timestamp 605 indicating when the user finalized their candidate choices 603, and a voter device digital signature 607. The voter device digital signature 607 is generated by the voter device 1 that generates the proposed ballot 609 using said voter device's 1 voter device private key 17a. The well-formedness of a proposed ballot 609 can be verified by checking that the proposed ballot 609 matches the structure depicted in FIG. 6, and that the voter device digital signature 607 represents a valid signature of the proposed ballot 609 by the voter device 1 identified by the voter device identification number 27.

FIG. 7 depicts a first embodiment of the recorded ballot 36 as well as an example of said first embodiment. Recorded ballots 36 are generated by the vote server 37 after a voter device 1 submits a proposed ballot 609 to said voter server during the ballot casting stage 173. A well-formed recorded ballot 36 first comprises a enclosed proposed ballot 701, which is an embodiment of the proposed ballot 609. A well-formed recorded ballot 36 also comprises a recorded-at timestamp 703 indicating when the vote server 37 generated the recorded ballot 36, and a vote server digital signature 705. The vote server digital signature 705 is generated by the vote server 37 using the vote server private key 19a. The well-formedness of a recorded ballot 36 can be verified by checking that the recorded ballot 36 matches the structure depicted in FIG. 7, and that the vote server digital signature 705 represents a valid signature of the recorded ballot 36 by the vote server 37.

FIG. 8 depicts a first embodiment of the signed binary merkle tree 49. The signed binary merkle tree 49 comprises a binary merkle tree 805 and a vote server digital signature 801. The binary merkle tree 805 is a tree comprising binary merkle tree nodes 803. Each binary merkle tree node 803 has exactly one parent node 803, except for the binary merkle tree root node 807 which has no parent node 803. The binary merkle tree root node 807 is an embodiment of the binary merkle tree node 803. Binary merkle tree node 803 are embodiments of the merkle tree node 1201. Each binary merkle tree node 803 comprises either no child nodes 803, a left child node 803, a right child node 803, or a left child node 803 and a right child node 803. Each binary merkle tree node 803 comprises a enclosed recorded ballot 1203 with a voter device identification number 601 greater than that of said binary merkle tree node 803's left child node 803, and greater than that of said left child node's 803 descendants. Each binary merkle tree node 803 has an enclosed recorded ballot 1203 with a voter device identification number 601 less than that of said binary merkle tree node's 803 right child node 803, and less than that of said right child node's 803 descendants. The well-formedness of a signed binary merkle tree 49 can be verified by checking that the signed binary merkle tree 49 matches the structure depicted in FIG. 8, and that the vote server digital signature 801 represents a valid signature of the signed binary merkle tree 49 by the vote server 37.

A wide variety of algorithms can be used to generate hashes. One such algorithm is the Secure Hash Algorithm 2 (SHA-2). The SHA-2 hash algorithm takes an arbitrary message as input, runs a sequence of mathematical operations on said input, and returns a constant-length mathematical summary of said input known as a hash. The SHA-2 hash function always returns the same output hash for the same input value. It is mathematically infeasible to find two different input values that map to the same SHA-2 output hash; such a series of input values is called a collision. Collisions are rare for the SHA-2 hash function and other secure hash functions.

FIG. 9 depicts a first embodiment of the binary merkle tree generation method 901. The binary merkle tree generation method 901 comprises step 903, step 905, step 907a, step 907b, step 909, step 911, step 913, step 915. The binary merkle tree generation method 901 is provided with a set of recorded ballots 36 as input, and returns a binary merkle tree 805 comprising said recorded ballots 36 as output. The method begins with step 903. Step 903 comprises the recorded ballots 36 being sorted in ascending order based on the enclosed proposed ballots' 701 voter device identification numbers 601. Any efficient sorting method can be used to complete step 903, such as mergesort or quicksort. Next, the method proceeds to step 905.

Step 905 comprises determining whether the sorted list of recorded ballots 36 is empty. If the sorted list of recorded ballots 36 is empty, the method proceeds to step 907a.

Step 907a comprises terminating the method and returning an empty binary merkle tree 805; the empty binary merkle tree 805 comprises zero binary merkle tree nodes 803. If the sorted list of recorded ballots 36 is not empty, the method proceeds to step 907b.

Step 907b comprises the creation of a new binary merkle tree 805 comprising a binary merkle tree root node 807, and no other binary merkle tree nodes 803. The binary merkle tree 805 of step 3b is generated such that the binary merkle tree root node 807's enclosed recorded ballot 1203 is an exact copy of the recorded ballot 36 in the middle of the sorted list of recorded ballots 36. Next, the method proceeds to step 909.

Step 909 comprises making a recursive call to the binary merkle tree generation method 901 with the recorded ballots 36 that are positioned to the left of the middle recorded ballot 36 in the sorted list of recorded ballots 36 (i.e. the left half of the sorted list of recorded ballots 36). Once the recursive call in step 909 completes, the binary merkle tree 805 returned by the recursive call is set as the left child node 803 of the binary merkle tree root node 807 from step 907b and the method proceeds to step 911.

Step 911 comprises making a recursive call to the binary merkle tree generation method 901 with the recorded ballots 36 that are positioned to the right of the middle ballot in the sorted list of recorded ballots 36 (i.e. the right half of the sorted list of recorded ballots 36). Once the recursive call in step 911 completes, the binary merkle tree 805 returned by the recursive call is set as the right child node 803 of the binary merkle tree root node 807 from step 3b, and the method proceeds to step 913.

Step 913 first comprises updating the binary merkle tree root node 807 from step 907b such that said children hashes 1205 of said root node 807 comprise the hashes of the said root node's 807 left child node 803 and said root node's 807 right child node 803. Step 913 then comprises updating the binary merkle tree root node 807 such that said root node's 807 hash represents the output of a hash function applied to the enclosed recorded ballot 1203 appended to the children hashes 1205. Finally, the method proceeds to step 915. Step 915 comprises terminating the binary merkle tree generation method 901 and returning the binary merkle tree 805 created during step 907b and edited during step 911, step 913, and step 915.

The method depicted in FIG. 9 returns a well-formed binary merkle tree 805. Every recorded ballot 36 provided in the input to the binary merkle tree generation method 901 corresponds to an enclosed recorded ballot 1203 in the binary merkle tree 805 outputted by the method 901.

The binary merkle tree generation method 901 generates a binary merkle tree 805; the binary merkle tree generation method 901 does not generate a signed binary merkle tree 49. In order to generate a well-formed signed binary merkle tree 49, the binary merkle tree 805 must be placed inside of a signed binary merkle tree 49 and the vote server digital signature 801 of the signed binary merkle tree 49 must be populated.

FIG. 10 depicts a first embodiment of the signed partial binary merkle tree 1007. The signed partial binary merkle tree 1007 comprises a partial binary merkle tree 1005 and a digital signature 1001. The partial binary merkle tree 1005 is a tree comprising partial binary merkle tree nodes 1003. Each partial binary merkle tree node 1003 has exactly one parent, except for the partial binary merkle tree root node 1009 which has no parent. The partial binary merkle tree root node 1009 is an embodiment of the partial binary merkle tree node 1003. Partial binary merkle tree nodes 1003 are embodiments of the merkle tree node 1201. The partial binary merkle tree root node 1009 is an embodiment of the partial binary merkle tree node 1003. Each partial binary merkle tree node 1003 comprises either no child nodes 1003, a left child node 1003, or a right child node 1003. Each partial binary merkle tree node 1003 comprises an enclosed recorded ballot 1203 with a voter device identification number 601 greater than the voter device identification number 601 of said partial binary merkle tree node's 1003 left child node 1003 and said left child node's 1003 descendants. Each partial binary merkle tree node 1003 has an enclosed recorded ballot 1203 with a voter device identification number 601 less than the voter device identification number 601 of said partial binary merkle tree node's 1003 right child node 1003 and said right child node's 1003 descendants. The well-formedness of a signed partial binary merkle tree 1007 can be verified by checking that the signed partial binary merkle tree 1007 matches the structure depicted in FIG. 10, and that the digital signature 1001 represents a valid signature of the signed partial binary merkle tree 1007 by the correct signatory.

FIG. 11 depicts a first embodiment of the partial binary merkle tree generation method 1101. The partial binary merkle tree generation method 1101 comprises step 1103, step 1105, step 1107a, step 1107b, step 1107c, step 1109, step 1111a, step 1111b, step 111c, and step 1112. The partial binary merkle tree generation method 1101 accepts a binary merkle tree 805 and a target recorded ballot 36 as input, and returns a partial binary merkle tree 1005. The returned partial binary merkle tree 1005 comprises partial binary merkle tree nodes 1003 that correspond to the input binary merkle tree's 805 binary merkle tree nodes 803. Specifically, each partial binary merkle tree node 1003 enclosed in the returned partial binary merkle tree 1005 is a substantial copy of a binary merkle tree node 803 that lies along a direct path from the binary merkle tree root node 807 to the binary merkle tree node 803 that comprises the target recorded ballot 36. All binary merkle tree nodes 803 that lie along said path are copied to partial binary merkle tree nodes 1003 in the returned partial binary merkle tree 1005. The method 1101 begins with step 1103. Step 1103 comprises creating a new partial binary merkle tree 1005 and copying the binary merkle tree root node 807 to the partial binary merkle tree root node 1009. Only the binary merkle tree root node 807 is copied during step 1103; the child nodes 803 of the binary merkle tree root node 807 are not copied.

Next, the method 1101 proceeds to step 1105. Step 1105 comprises obtaining the voter device identification number 601 of the target recorded ballot's 36 enclosed proposed ballot 701 (the target voter device identification number 601), obtaining the enclosed recorded ballot 1203 of the partial binary merkle tree root node 1009 (the root node recorded ballot 36), obtaining the voter device identification number 601 of the root node recorded ballot's 36 enclosed proposed ballot 701 (the root node voter device identification number 601), and determining whether the target voter device identification number 601 is less than, equal to, or greater than the root node voter device identification number 601.

During step 1105, if the target voter device identification number 601 is less than the root node voter device identification number 601, the method 1101 proceeds to step 1107a. Step 1107a comprises copying the left child node 803 of the binary merkle tree root node 807 to the left child node 1003 of the partial binary merkle tree root node 1009, then proceeding to step 1109. Only the left child node 803 is copied during step 1107a; the left child node's 803 children nodes 803 are not copied.

During step 1105, if the target voter device identification number 601 is equal to the root node voter device identification number 601, the method 1101 proceeds to step 1107b. Step 1107b comprises terminating the partial binary merkle tree generation method 1101 and returning the partial binary merkle tree 1005 generated during step 1103.

During step 1105, if the target voter device identification number 601 is greater than the root node voter device identification number 601, the method 1101 proceeds to step 1107c. Step 1107c comprises copying the right child node 803 of the binary merkle tree root node 807 to the right child node 1003 of the partial binary merkle tree root node 1009, then proceeding to step 1109. Only the right child node 803 is copied during step 1170c; the right child node's 803 children nodes 803 are not copied.

Step 1109 comprises obtaining the target voter device identification number 601, obtaining the partial binary merkle tree node 1003 most recently copied to the partial binary merkle tree 1005 (the most recent partial binary merkle tree node 1003), obtaining the binary merkle tree node 803 most recently copied from the binary merkle tree 805 (the most recent binary merkle tree node 803), obtaining the enclosed recorded ballot 1203 of the most recent binary merkle tree node 803 (the most recent recorded ballot 36), obtaining the voter device identification number 601 of the most recent enclosed recorded ballot's 36 enclosed proposed ballot 701 (the most recent voter device identification number 601), and determining whether the target voter device identification number 601 is less than, equal to, or greater than the most recent voter device identification number 601.

During step 1109, if the target voter device identification number 601 is less than the most recent voter device identification number 601, the method 1101 proceeds to step 1111a. Step 1111a comprises copying the left child node 803 of the most recent binary merkle tree node 803 to the left child node 1003 of the most recent partial binary merkle tree node 1003, then proceeding to step 1112. Only the left child node 803 is copied during step 1111a; the left child node's 803 children nodes 803 are not copied.

During step 1109, if the target voter device identification number 601 is equal to the most recent voter device identification number 601, the method 1101 proceeds to step 1111b. Step 1111b comprises terminating the election method 169 and returning the partial binary merkle tree 1005.

During step 1109, if the target voter device identification number 601 is greater than the most recent voter device identification number 601, the method 1101 proceeds to step 1111c. Step 1111c comprises copying the right child node 803 of the most recent binary merkle tree node 803 to the right child node 1003 of the most recent partial binary merkle tree node 1003, then proceeding to step 1112. Only the right child node 803 is copied during step 111c; the right child node's 803 children nodes 803 are not copied.

Step 1112 comprises returning to step 1109.

The partial binary merkle tree generation method 1101 depicted in FIG. 11 returns a well-formed partial binary merkle tree 1005. Said partial binary merkle tree 1005 effectively represents a copy of the binary merkle tree 805 provided as input, except binary merkle tree nodes 803 are not copied to partial binary merkle tree nodes 1003 unless said binary merkle tree nodes 803 lie along a direct path from the binary merkle tree root node 807 to the binary merkle tree node 803 that comprises the target recorded ballot 36.

The partial binary merkle tree generation method 1101 only generates a partial binary merkle tree 1005; the partial binary merkle tree generation method 1101 does not generate a signed partial binary merkle tree 1007. In order to generate a well-formed signed partial binary merkle tree 1007, the partial binary merkle tree 1005 must be placed inside of a signed partial binary merkle tree 1007 and the digital signature 1001 of the signed partial binary merkle tree 1007 must be populated.

FIG. 12 depicts the structure of a first embodiment of a merkle tree node 1201. The merkle tree node 1201 first comprises an enclosed recorded ballot 1203, which is an embodiment of the recorded ballot 36. The merkle tree node 1201 also comprises a list of children hashes 1205, which represent the hashes 1207 of the merkle tree node's 1201 children nodes 1201. The merkle tree node 1201 also comprises a hash 1207, which represents the output of a hash function applied to the enclosed recorded ballot 1203 appended to the children hashes 1205. The binary merkle tree node 803 is an embodiment of the merkle tree node 1201. The partial binary merkle tree node 1003 is an embodiment of the merkle tree node 1201.

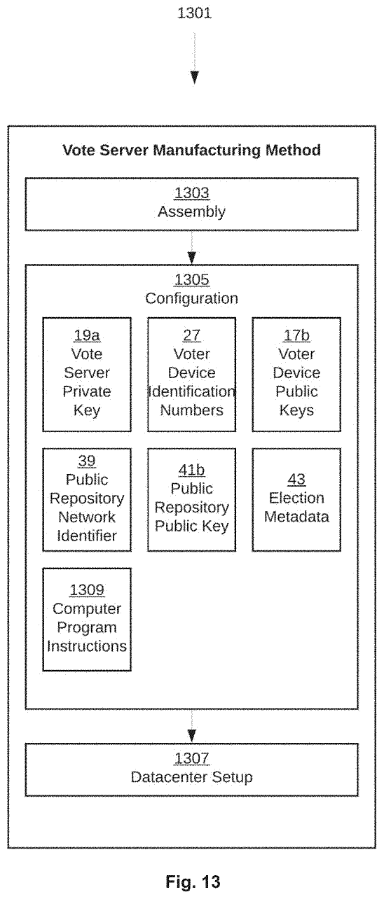

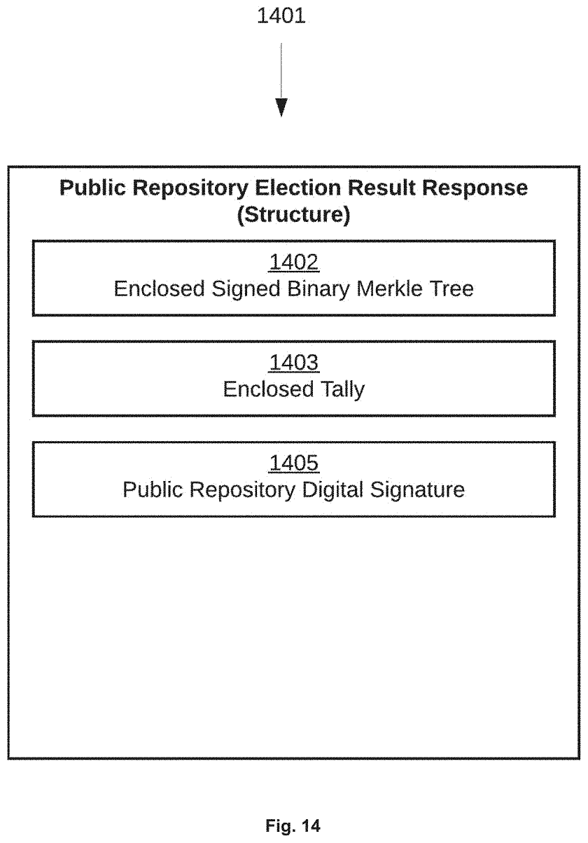

FIG. 13 depicts a first embodiment of the vote server manufacturing method 1301. The vote server manufacturing method 1301 comprises three stages: the assembly stage 1303, the configuration stage 1305, and the datacenter setup stage 1307. The assembly stage 1303 comprises the vote server 37 being assembled in a factory or other assembly location. The configuration stage 1305 comprises an election administrator loading one or more configuration settings to the vote server's 37 memory 2305, 2307. The configuration settings comprise a vote server private key 19a, voter device identification numbers 27, voter device public keys 17b, a public repository network identifier 39, a public repository public key 41b, election metadata 43, and a set of computer program instructions 1309. The public repository network identifier 39 is used by the vote server 37 to locate and communicate the public repository 47 over the computer network. In the first embodiment, the public repository network identifier 39 comprises an Internet Protocol (IP) address. In alternative embodiments, the public repository network identifier 39 may comprise a domain name, a Media Access Control (MAC) address, or any other identifier that allow the vote server 37 to locate and communicate with the public repository 47 over the computer network. The computer program instructions 1309 are configured such that, after the vote server 37 powers on, the vote server 37 executes the election method 169 by running the computer program instructions 1309. The datacenter setup stage 1307 comprises election administrators placing the vote server 37 in a datacenter and powering on the vote server 37.

The public repository private key 41a is mathematically associated with the public repository public key 41b such that digital signatures generated with the public repository private key 41a can be validated with the public repository public key 41b.

In the first embodiment of the election method 169, only one vote server 37 is used. In alternative embodiments, a plurality of vote servers 37 may be used. The plurality of vote servers 37 may access a common memory 2305, 2307. A load balancer may be used to balance network requests across the plurality of vote servers 37.

FIG. 14 depicts a first embodiment of the public repository election result response 1401. A well-formed public repository election result response 1401 first comprises an enclosed signed binary merkle tree 1402. The enclosed signed binary merkle tree 1402 is an embodiment of the signed binary merkle tree 49. A well-formed public repository election result response 1401 also comprises an enclosed tally 1403. The enclosed tally 1403 is an embodiment of the tally 51. The public repository election result response 1401 also comprises a public repository digital signature 1405, which is generated by the public repository 47 using the public repository private key 41a. The well-formedness of a public repository election result response 1401 can be verified by checking that the public repository election result response 1401 matches the structure depicted in FIG. 14 and that the public repository digital signature 1405 represents a valid signature of the public repository election result response 1401 by the public repository 47.

FIG. 15 depicts a first embodiment of the audit server manufacturing method 1501. The audit server manufacturing method 1501 comprises three stages: the assembly stage 1503, the configuration stage 1505, and the datacenter setup stage 1507. The assembly stage 1503 comprises the audit server 45 being assembled in a factory or other assembly location. The configuration stage 1505 comprises an election administrator loading one or more configuration settings to the audit server's 45 memory 2305, 2307. The configuration settings comprise an audit server private key 21a, a vote server public key 19b, voter device identification numbers 27, voter device public keys 17b, a public repository network identifier 39, election metadata 43, and a set of computer program instructions 1509. The public repository network identifier 39 is used by the audit server 45 to locate and communicate the public repository 47 over the computer network. In the first embodiment, the public repository network identifier 39 comprises an Internet Protocol (IP) address. In alternative embodiments, the public repository network identifier 39 may comprise a domain name, a Media Access Control (MAC) address, or any other identifier that allow the audit server 45 to locate and communicate with the public repository 47 over the computer network. The computer program instructions 1509 are configured such that, after the audit server 45 powers on, the audit server 45 executes the election method 169 by running the computer program instructions 1509. The datacenter setup stage 1507 comprises election administrators placing the audit server 45 in a datacenter and powering on the audit server 45.

FIG. 16 depicts a network diagram of a first embodiment of the election system 1601. Data flows from one or more voter devices 1 to one or more audit servers 45 over a computer network, and vice versa. Data flows from one or more voter devices 1 to the vote server 37 over a computer network, and vice versa. Data flows from the vote server 37 to the public repository 47 over a computer network, and vice versa. Data flows from the public repository 47 to one or more audit servers 45 over a computer network, and vice versa. In the first embodiment, data flows over the internet. In alternative embodiments, data may flow over alternative computer networks such as Local Area Networks (LAN) or any computer networks that allow for efficient communication.

In the first embodiment, one instance of the election system 1601 is setup for an election. In alternative embodiments, several instances of the election system 1601 are setup for an election; for example, a separate instance of the system is created for each voting district.

In the first embodiment, the election system 1601 comprises one public repository 47, one vote server 37, one or more voter devices 1, and one or more audit servers 45. In alternative embodiments, the election system 1601 may comprise a plurality of vote servers 37. In alternative embodiments, the election system 1601 may comprise a plurality of public repositories 47.

In the first embodiment, the election system 1601 is used to conduct governmental elections such as presidential and senatorial races. In alternative embodiments, the election 1601 can be used for other elections such as corporate elections, school elections, or any other elections that require secure vote counting.

In the first embodiment, the election system 1601 is managed by a centralized election authority such as a government official or government agency. In alternative embodiments, the election system 1601 may be decentralized.

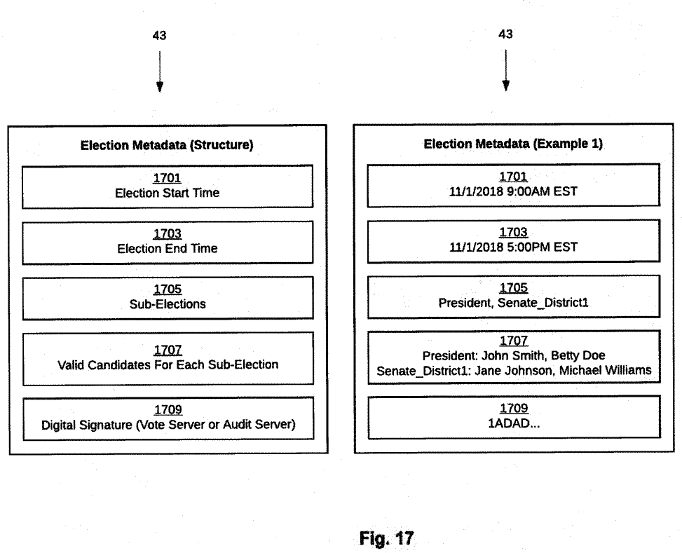

FIG. 17 depicts a first embodiment of the election metadata 43. The election metadata 43 comprises an election start time 1701, an election end time 1703, a list of sub-elections 1905, a list of valid candidates for each sub-election 1707, and a digital signature 1709. The election start time 1701 and election end time 1703 represent when polls are open. When polls are not open, the voter device 1 does not attempt to vote and the vote server 37 refuses to record ballots. The list of sub-elections 1905 represents the decisions that voters will make during the election. In the depicted example, the voter is asked to vote for a U.S. president and for a senator in a specific voting district. The list of valid candidates for each sub-election 1707 represents the options voters choose from for each sub-election 1905. In the depicted example, the voter is asked to choose between John Smith and Betty Doe for the presidential election, and between Jane Johnson and Michael Williams for the senatorial election. When election metadata 43 is returned by the vote server 37 during the election method 169, the digital signature 1709 must represent a valid digital signature generated using the vote server's 37 vote server private key 19a. When election metadata 43 is returned by an audit server 45 during the election method 169, the digital signature 1709 must represent a valid digital signature generated using the audit server's 45 audit server private key 21a. The well-formedness of election metadata 43 can be verified by checking that the election metadata 43 matches the structure depicted in FIG. 17, and that the digital signature 1709 represents a valid signature of the election metadata 43 by the correct signatory.

FIG. 18 depicts a first embodiment of the audit server ballot submission success response 1801. Audit server ballot submission success responses 1801 are generated by the audit server 45 in response to a voter device 1 submitting a proposed ballot 609 to said audit server 45. A well-formed audit server ballot submission success response 1801 first comprises an enclosed recorded ballot 1803, which must match the recorded ballot 36 submitted to the audit server 45 by the voter device 1. The enclosed recorded ballot 1803 is an embodiment of the recorded ballot 36. The audit server ballot submission success response 1801 also comprises a timestamp 1805 and an audit server digital signature 1807. The timestamp 1805 represents the time when the audit server 45 generated the audit server ballot submission success response 1801. The digital signature is generated by the audit server 45 that generates the audit server ballot submission success response 1801 using said audit server's 45 audit server private key 21a. The well-formedness of a audit server ballot submission success response 1801 can be verified by checking that the audit server ballot submission success response 1801 matches the structure depicted in FIG. 18, and that the audit server digital signature 1807 represents a valid digital signature of the audit server ballot submission success response 1801 by the audit server 45 that generated the audit server ballot submission success response 1801.

FIG. 19 depicts a first embodiment of the tally 51. The tally 51 comprises a list of sub-elections 1905, vote counts for each candidate in each sub-election 1905, and a vote server digital signature 1907. The well-formedness of a tally 51 can be verified by checking that the tally 51 matches the structure depicted in FIG. 19 and that the vote server digital signature 1907 represents a valid signature of the tally 51 by the vote server 37.

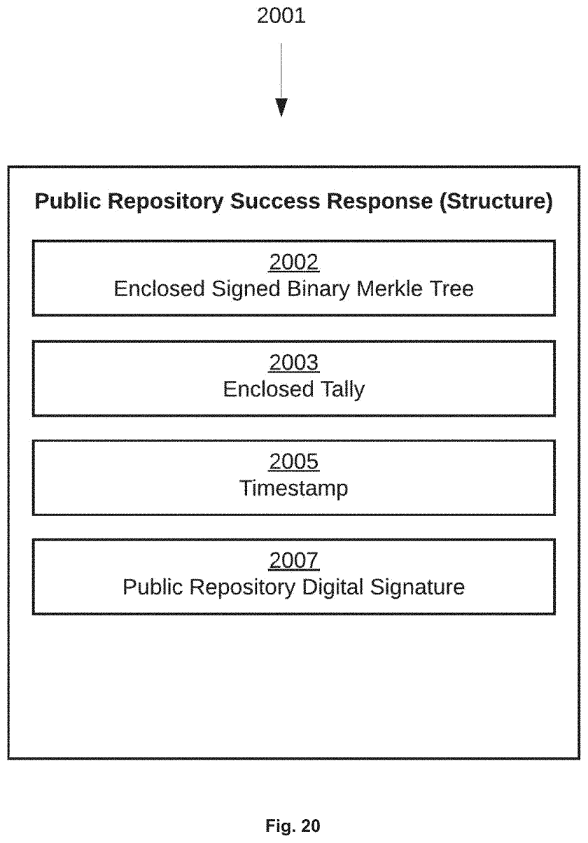

FIG. 20 depicts a first embodiment of the public repository success response 2001. Public repository success responses 2001 are generated by the public repository 47 in response to a vote server 37 submitting a signed binary merkle tree 49 and tally 51 to said public repository 47. A well-formed public repository success response 2001 first comprises an enclosed signed binary merkle tree 2002, which must match the signed binary merkle tree 49 submitted to the public repository 47 by the vote server 37. The enclosed signed binary merkle tree 2002 is an embodiment of the signed binary merkle tree 49. A well-formed public repository success response 2001 also comprises an enclosed tally 2003, which must match the tally 51 submitted to the public repository 47 by the vote server 37. The enclosed tally 2003 is an embodiment of the tally 51. The public repository success response 2001 also comprises a timestamp 2005 and a public repository digital signature 2007. The timestamp 2005 comprises the time when the public repository 47 generated the public repository success response 2001. The public repository digital signature 2007 is generated by the public repository 47 using the public repository private key 41a. The well-formedness of a public repository success response 2001 can be verified by checking that the public repository success response 2001 matches the structure depicted in FIG. 20 and that the public repository digital signature 2007 represents a valid signature of the public repository success response 2001 by the public repository 47.

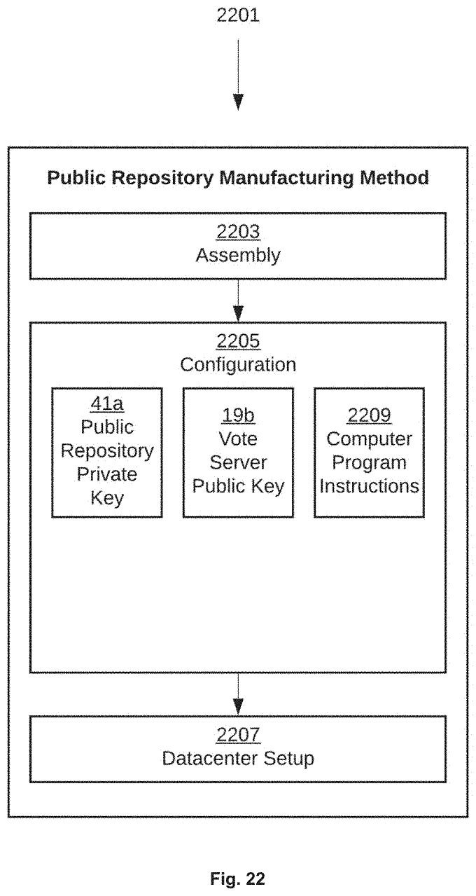

FIG. 22 depicts a first embodiment of the public repository manufacturing method 2201. The public repository manufacturing method 2201 comprises three stages: the assembly stage 2203, the configuration stage 2205, and the datacenter setup stage 2207. The assembly stage 2203 comprises the public repository 47 being assembled in a factory or other assembly location. The configuration stage 2205 comprises an election administrator loading one or more configuration settings to the public repository's 47 memory 2305, 2307. The configuration settings comprise a public repository private key 41a, a vote server public key 19b, and a set of computer program instructions 2209. The computer program instructions 2209 are configured such that, after the public repository 47 powers on, the public repository 47 executes the election method 169 by running the computer program instructions 2209. The datacenter setup stage 2207 comprises election administrators placing the public repository 47 in a datacenter and powering on the public repository 47.

Throughout the present specification, it is periodically stated that digital signatures are generated by audit servers 45, vote servers 37, voter devices 1, and public repositories 47. It is to be understood that, when a digital signature is generated by an audit server 45, said digital signature is generated using said audit server's 45 audit server private key 21a. It is to be understood that, when a digital signature is generated by a vote server 37, said digital signature is generated using said vote server's 37 vote server private key 19a. It is to be understood that, when a digital signature is generated by a voter device 1, said digital signature is generated using said voter device's 1 voter device private key 17a. It is to be understood that, when a digital signature is generated by a public repository 47, said digital signature is generated using said public repository's 47 public repository private key 41a.

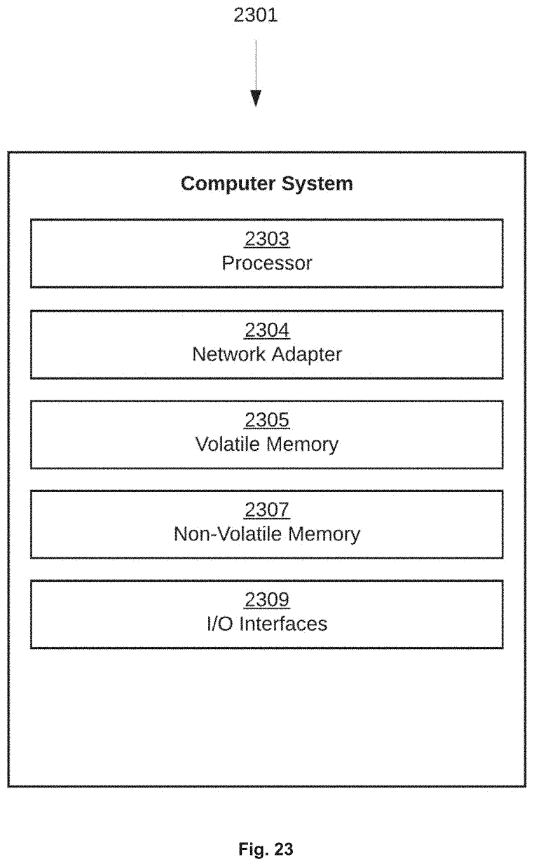

FIG. 23 illustrates a schematic of an example computer system 2301 that may implement any portion of the voter devices 1, audit servers 45, or vote servers 37. The computer system 2301 may comprise one or more processors 2303, a network adapter 2304, a volatile memory 2305, a non-volatile memory 2307, and one or more I/O interfaces 2309. The processor 2303 may comprise a software module that performs the methods described herein. Said software module may be programmed into the integrated circuits of the processor 2303, or loaded from memory 2305, 2307 or a computer network or combinations thereof. The computer system 2301 can communicate with one or more computer networks via its network adapter 2304. The computer system 2301 can communicate with networks such as local area networks (LAN), general wide area networks (WAN), and/or public networks (e.g., the Internet) via its network adapter 2304. The volatile memory 2305 may comprise any volatile computer system 2301 readable media such as random access memory (RAM). The non-volatile memory 2307 may comprise any non-volatile computer system readable media such as a hard drive (HDD) or solid-state drive (SSD). The I/O interfaces 2309 may comprise one or more of a Light Emitting Diode, a digital display, a printer, a keyboard, a mouse, a touchscreen, or any other devices that allow for information to be inputted into and retrieved from the computer system 2301.

Examples of well-known computer systems 2301 that may implement the voter devices 1, audit servers 45, or vote servers 37 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, distributed cloud computing environments that include any of the preceding systems or devices, and in general any type of computing device.

Processors 2303 may be implemented by hardware processors including Central Processing Units (CPUs), Graphics Processing Units (GPUs), or any other processors that allow for the execution of computer program instructions 413, 1309, 1509, and 2209.

Any combination of one or more computer readable medium(s) 2305, 2307 may be utilized by the computer system 2301. A computer readable medium 2305, 2307 may be a computer readable storage medium 2305, 2307. A computer readable medium 2305, 2307 may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium 2305, 2307 would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium 2305, 2307 may be any tangible medium that can contain, or store a program for use by or in connection with an instruction execution system, apparatus, or device.

Computer program instructions 413, 1309, 1509, and 2209 embodied on a computer readable medium 2305, 2307 may be transmitted using any appropriate medium, including but not limited to wireless, wireline, optical fiber cable, RF, etc., or any suitable combination of the foregoing.

Computer program instructions 413, 1309, 1509, and 2209 for carrying out operations for aspects of the disclosed embodiments may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog, and/or low-level languages such as assembly.

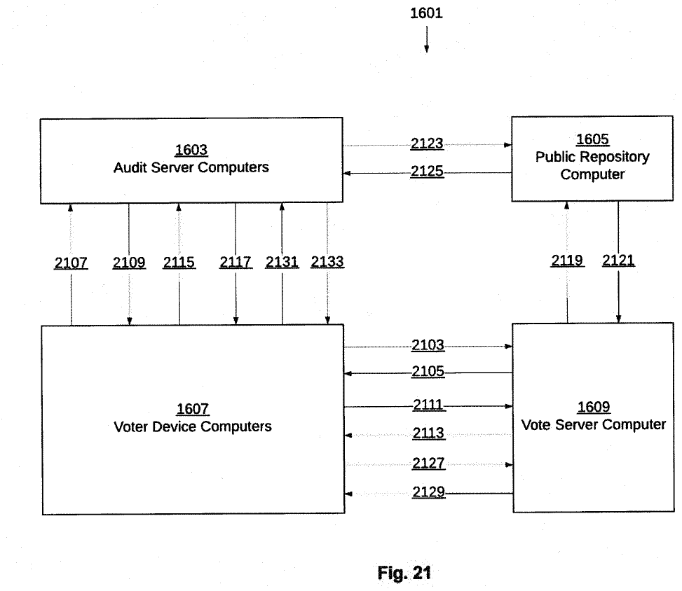

FIG. 21 depicts a network diagram of a second embodiment of the election system 1601. Each voter device computer 1607 is an embodiment of the voter device 1. Each audit server computer 1603 is an embodiment of the audit server 45. The vote server computer 1609 is an embodiment of the vote server 37. The public repository computer 1605 is an embodiment of the public repository 47. Each voter device computer 1607 begins by sending a first network request 2103 to the vote server computer 1609 to request election metadata 43. The vote server computer 1609 then sends a first network response 2105 to the voter device computer 1607 comprising the requested election metadata 43. The voter device computer 1607 then sends a second network request 2107 to each audit server computer 1603 to request election metadata 43. Each audit server computer 1603 then sends a second network response 2109 to the voter device computer 1607 comprising the requested election metadata 43. The voter device computer 1607 then sends a third network request 2111 to the vote server computer 1609 comprising a proposed ballot 609. The vote server computer 1609 then sends a third network response 2113 to the voter device computer 1607 comprising a recorded ballot 36. The voter device computer 1607 then sends a fourth network request 2115 to each audit server computer 1603 with the recorded ballot. Each audit server computer 1603 then sends a fourth network response 2117 to the voter device computer 1607 comprising an audit server ballot submission success response 1801. Once polls close, the vote server computer 1609 sends a fifth network request 2119 to the public repository computer 1605 comprising a signed binary merkle tree 49 and tally 51. The public repository computer 1605 then sends a fifth network response 2121 to the vote server computer 1609 comprising a public repository success response 2001. Each audit server computer 1603 then sends a sixth network request 2123 to the public repository computer 1605 to request the election results 49, 51. The public repository computer 1605 then sends a sixth network response 2125 to each audit server computer 1603 comprising a public repository election result response 1401. The voter device computer 1607 then sends a seventh network request 2127 to the vote server computer 1609 requesting a signed partial binary merkle tree 1007. The vote server computer 1609 then sends a seventh network response 2129 to the voter device computer 1607 comprising a signed partial binary merkle tree 1007. The voter device computer 1607 then sends an eighth network request 2131 to each audit server computer 1603 requesting a signed partial binary merkle tree 1007. Each audit server computer 1603 then sends an eighth network response 2133 to the voter device computer 1607 comprising a signed partial binary merkle tree 1007.

Aspects of the disclosed embodiments may be embodied as a system, method, or computer program product or apparatus. Accordingly, aspects of the disclosed embodiments may take the form of an entirely hardware embodiment, an entirely software embodiment (including firmware, resident software, micro-code, or computer program instructions 413, 1309, 1509, and 2209) or an embodiment combining software and hardware aspects that may all generally be referred to herein as a “circuit,” “module” or “system.” Furthermore, aspects of the disclosed embodiments may take the form of a computer program product embodied in one or more computer readable medium(s) 2305, 2307 having computer program instructions 413, 1309, 1509, and 2209 embodied thereon. These computer program instructions 413, 1309, 1509, and 2209 may be provided to a processor 2303 of a general purpose computer, special purpose computer, or other programmable data processing apparatus to produce a machine, such that the instructions, which execute via the processor 2303 of the computer system 2301 or other programmable data processing apparatus, create means for implementing the systems or methods described herein.

Computer program instructions 413, 1309, 1509 may be secured via the use of a Trusted Platform Module (TPM). A TPM can be used to cryptographically attest that the said program, software, or computer program instructions 413, 1309, 1509, and 2209 are valid and have not been modified by an unauthorized third party (i.e. malware). Non-limiting examples of TPM include the TPM described in ISO standard ISO/IEC 11889, TPM 1.2, TPM 2.0, or any other hardware devices that cryptographically attest to the validity of software.

The flowchart and block diagrams in the figures illustrate the architecture, functionality, and operation of possible implementations of systems, methods and computer program products according to various embodiments of the disclosed embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer program instructions.

The terminology and description provided herein is for the purpose of describing particular embodiments only and is not intended to be limiting. A number of alternatives, modifications, variations, or improvements therein may be subsequently made by those skilled in the art, which are also intended to be encompassed by the following claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A non-volatile computer readable medium comprising a first set of computer program instructions that, when executed by a first hardware processor, configure the first hardware processor to:
a. collect a candidate choice from a voter through a voter device, wherein the voter device comprises a Physical submit button, a Dhysical finalize button, and a hardware trusted platform module;
b. send a proposed ballot to a vote server over a computer network;
c. receive a first recorded ballot from the vote server over the computer network, wherein the first recorded ballot comprises a digital signature and the digital signature is generated by the vote server;
d. send the first recorded ballot to an audit server over the computer network, and;
e. utilize the trusted platform module to calculate a mathematical summary of the computer program instructions and validate the mathematical summary; and
comprising a second set of computer program instructions that, when executed by a second hardware processor, configure the second hardware processor to:
f. receive the proposed ballot from the voter device over the computer network;
g. generate the recorded ballot;
h. send the recorded ballot to the voter device over the computer network;
i. send a first tree to a public repository over the computer network, wherein the first tree comprises the recorded ballot; and
j. send a second tree to the voter device over the computer network, wherein the second tree comprises the recorded ballot.

2. The medium of claim 1, wherein the first set of computer program instructions further configure the first hardware processor to:
k. receive the first tree over the computer network, wherein the first tree comprises the recorded ballot; and
l. validate that the first recorded ballot is included in the first tree.

3. The medium of claim 2, wherein the first tree comprises a partial binary merkle tree.

4. The medium of claim 1, wherein the first set of computer program instructions further configure the first hardware processor to:
m. receive a mathematical summary of the first tree over the computer network, wherein the first tree comprises the recorded ballot.

5. The medium of claim 1, wherein the first set of computer program instructions further configure the first hardware processor to:
n. receive election metadata over the computer network from the audit server or the vote server.

6. The medium of claim 1, wherein the first set of computer program instructions do not configure the first hardware processor to communicate with a blockchain.

7. (canceled)

8. A method of manufacturing the medium of claim 1, comprising assembling the medium; loading one or more configuration settings onto the medium, wherein the configuration settings comprise a voter device public key, a voter device private key, and one or more computer program instructions; and supplying the medium to said voter.

9. The method of claim 8, wherein the configuration settings further comprise a vote server public key, a vote server network identifier, one or more audit server public keys, one or more audit server network identifiers, and a voter device identification number.

10. The method of claim 8, wherein the configuration settings are loaded onto the medium by a centralized election authority.

11. A system comprising a first hardware processor and a second hardware processor, the first hardware processor being configured to:
a. collect a candidate choice from a voter via a voter device, wherein the voter device comprises a Physical submit button, a physical finalize button, and a hardware trusted platform module;
b. send a proposed ballot to a vote server over a computer network;
c. receive a recorded ballot from the vote server over the computer network, wherein the recorded ballot comprises a digital signature and the digital signature is generated by the vote server;
d. send the recorded ballot to an audit server over the computer network; and
e. utilize the trusted platform module to calculate a mathematical summary of the computer program instructions and validate the mathematical summary;
the second hardware processor being configured to:
f. receive the proposed ballot from the voter device over the computer network;
g. generate the recorded ballot;
h. send the recorded ballot to the voter device over the computer network;
i. send a first tree to a public repository over the computer network, wherein the first tree comprises the recorded ballot; and
j. send a second tree to the voter device over the computer network, wherein the second tree comprises the recorded ballot.

12. (canceled)

13. (canceled)

14. The system of claim 11, further comprising a third hardware processor configured to:
k. receive the recorded ballot from the voter device over the computer network;
l. receive the first tree from the public repository;
m. validate that the first tree comprises the recorded ballot; and
n. send a third tree to a voter device over a computer network, wherein the third tree comprises the recorded ballot.

15. The system of claim 14, wherein the second hardware processor and the third hardware processor are the same hardware processor.

16. A method of conducting an electronic election that is implemented by at least one hardware processor, the method comprising:
a. collecting a candidate choice from a voter via a voter device, wherein the voter device comprises a physical submit button, a physical finalize button, and a hardware trusted platform module;
b. sending a proposed ballot to a vote server over a computer network;
c. receiving a first recorded ballot from the vote server over the computer network, wherein the first recorded ballot comprises a digital signature and the digital signature is generated by the vote server;
d. sending the first recorded ballot to an audit server over the computer network;
e. receiving a first tree over the computer network, wherein the first tree comprises a recorded ballot;
f. validating that the first recorded ballot is included in the first tree;
g. sending the first tree to a public repository over the computer network, wherein the first tree comprises the recorded ballot; and
h. sending a second tree to the voter device over the computer network, wherein the second tree comprises the recorded ballot;
i. utilizing the trusted platform module to calculate a mathematical summary of the computer program instructions and validate the mathematical summary;
j. calculating a first partial binary merkle tree by accepting a binary merkle tree and a target recorded ballot, calculating a direct path in the binary merkle tree from a root node to the target recorded ballot, and copying all nodes along the direct path to the first partial binary merkle tree;
k. sending the first partial binary merkle tree to the voter device; and
l. validating that the first partial binary merkle tree is consistent with a second partial binary merkle tree.

17. (canceled)

18. (canceled)

19. The method of claim 16, further comprising:
m. receiving a mathematical summary of the first and second partial binary merkle trees over the computer network, wherein the tree comprises a recorded ballot.

20. The method of claim 16, further comprising:
n. receiving election metadata over the computer network from the audit server or the vote server.

21. The system of claim 11, further comprising a fourth hardware processor configured to:
o. receive the first recorded ballot from the public repository over the computer network;
p. validate that the first recorded ballot is digitally signed by a voter device private key; and
q. validate that the first recorded ballot is digitally signed by a vote server private key.

22. The method of claim 16, further comprising:
o. receiving the first recorded ballot from the public repository over the computer network;
p. validating that the first recorded ballot is digitally signed by a voter device private key; and
p. validating that the first recorded ballot is digitally signed by a vote server private key.

23. The medium of claim 1, wherein the first set of computer program instructions further configure the first hardware processor to:
o. send the first recorded ballot to a supplemental second server over the computer network, wherein the supplemental second server comprises computer program instructions that, when executed by a third hardware processor, configure the third hardware processor to validate that the first recorded ballot is published to the public repository.
